(19) United States
(12) Patent Application Publication
(10) Pub. No.: US 2013/0025571 A1
(43) Pub. Date: Jan. 31, 2013

(54) INTERNAL COMBUSTION ENGINE

(71) Applicant: Takeshi Ashizawa, Yokohama-shi (JP)

(72) Inventor: Takeshi Ashizawa, Yokohama-shi (JP)

(73) Assignee: TOYOTA JIDOSHA KABUSHIKI KAISHA, Toyota-shi, Aichi (JP)

(21) Appl. No.: 13/640,584

(22) PCT Filed: Apr. 21, 2010
(86) PCT No.: PCT/JP2010/057516

§ 371 Date: Oct. 11, 2012

(51) Int. Cl. F02D 15/04

(52) U.S. Cl. 123/48 R

(57) ABSTRACT

An internal combustion engine is provided with an exhaust valve which has a tapered plug part, a tube-shaped member which is arranged in a region where the exhaust valve is arranged and which is engaged with the tapered plug part of the exhaust valve at one end part which faces a combustion chamber, and a fluid spring for biasing the tube-shaped member to the side facing the combustion chamber. The tube-shaped member is formed so as to be able to move substantially parallel to the direction of movement of the exhaust valve and the other part abuts against the fluid spring. The fluid spring is formed so as to contract using the change in pressure of the combustion chamber as a drive source when the pressure of the combustion chamber reaches a predetermined control pressure.

### TECHNICAL FIELD

The present invention relates to an internal combustion engine.

### BACKGROUND ART

An internal combustion engine supplies a combustion chamber with fuel and air and burns the fuel in the combustion chamber to output a drive force. When burning fuel in the combustion chamber, the air-fuel mixture of the air and fuel is compressed in state. It is known that the compression ratio of the internal combustion engine has an effect on the output and fuel consumption. By raising the compression ratio, it is possible to increase the output torque or reduce the fuel consumption.

Japanese Patent Publication No. 2000-230439 A1 discloses a self-ignition type internal combustion engine which provides a combustion chamber with a sub chamber which is communicated through a pressure regulator, wherein the pressure regulator has a valve element and a valve shaft which is connected to the valve element and is biased to the combustion chamber side. It is disclosed that this self igniting type internal combustion engine pushes up the pressure regulator against the pressure of an elastic member and releases the pressure to the sub chamber when overly early ignition etc. causes the combustion pressure to exceed a predetermined allowable pressure value. This publication discloses a pressure regulator which operates by a pressure larger than the pressure which occurs due to overly early ignition etc. Japanese Patent Publication No. 2006-522895 A1 discloses a piston wherein between the piston and a connecting shaft, a disk spring is assembled which acts so as to bias the connecting shaft in a direction opposite to the piston crown. Further, it discloses that the piston crown moves on an axis relative to the connecting shaft. It discloses that in this piston, when the piston passes top dead center, the energy which had been stored in the disk spring is released leading to the generation of an output torque.

### CITATION LIST

### Patent Literature

PLT 1: Japanese Patent Publication No. 2000-230439 A1
PLT 2: Japanese Patent Publication No. 2006-522895 A1

### SUMMARY OF INVENTION

### Technical Problem

In a spark ignition type of internal combustion engine, a mixture of fuel and air is ignited in a combustion chamber by an ignition device, whereby the air-fuel mixture burns and the piston is pushed down. At this time, the compression ratio becomes higher, whereby the heat efficiency is improved. In this regard, if raising the compression ratio, sometimes abnormal combustion occurs. For example, self-ignition sometimes occurs when the compression ratio becomes higher.

To prevent the occurrence of abnormal combustion, the ignition timing can be retarded. However, by retarding the ignition timing, the output torque becomes smaller or the fuel consumption efficiency deteriorates. Further, by retarding the ignition timing, the temperature of the exhaust gas becomes higher. For this reason, sometimes high quality materials become necessary for the component parts of the exhaust purification device or a device for cooling the exhaust gas becomes necessary. Furthermore, to lower the temperature of the exhaust gas, sometimes a value of the air-fuel ratio when burning fuel in the combustion chamber is made less than the stoichiometric air-fuel ratio. That is, sometimes the air-fuel ratio at the time of combustion is made rich. However, there was the problem that when a three-way catalyst is arranged as the exhaust purification device, if the air-fuel ratio of the exhaust gas deviates from the stoichiometric air-fuel ratio, the purification ability ends up becoming smaller and the exhaust gas can no longer be sufficiently purified.

In the internal combustion engine which is disclosed in the above Japanese Patent Publication No. 2000-230439 A1, a space which communicates with the combustion chamber is formed in the cylinder head and a mechanical spring is arranged in this space. However, a passage connecting to the combustion chamber is formed in the cylinder head, so the intake valve or the exhaust valve is liable to become smaller.

The above Japanese Patent Publication No. 2006-522895 A1 discloses an internal combustion engine wherein a mechanical spring is arranged in a piston. However, the mechanical spring which is arranged in the piston is insufficient in amount of possible deformation. A sufficient stroke is liable to be unable to be secured. For this reason, control of the pressure inside of the cylinder was difficult.

The present invention has as its object the provision of an internal combustion engine which suppresses the occurrence of abnormal combustion.

### Solution to Problem

An internal combustion engine of the present invention is provided with an on-off valve which has a shaft-shaped part and tapered plug part and is formed to be able to open and close a passage which is communicated with a combustion chamber, a support structure which includes a passage which communicates with the combustion chamber and which supports the on-off valve, an interposed member which is arranged in a region where the on-off valve is arranged in the passage which communicates with the combustion chamber and which is engaged with the tapered plug part of the on-off valve at one end part which faces the combustion chamber, and a spring device for biasing the interposed member to the side which faces the combustion chamber. The interposed member is formed to be able to move substantially parallel to a direction of movement of the on-off valve and abuts against the spring device at the other end part at the opposite side from the one end part. The spring device is formed so as to contract using the change in pressure of the combustion chamber as a drive source when the pressure of the combustion chamber reaches a predetermined control pressure. When the combustion chamber reaches the control pressure during the time period from the compression stroke to the expansion stroke of a combustion cycle, the spring device contracting causes the tapered plug part and the interposed member to move toward the outside of the combustion chamber and the combustion chamber to increase in volume.

In the present invention, the internal combustion engine may be provided with an operating state detecting device which detects an operating state of the internal combustion engine and a movement restricting device which restricts the amount of movement of the interposed member, may detect the operating state of the internal combustion engine, may select the maximum pressure of the combustion chamber in accordance with the detected operating state, and may use the selected maximum pressure of the combustion chamber as the basis to restrict the amount of movement of the interposed member.

In the present invention, the internal combustion engine may be provided with a blocking device which blocks at least part of the passage which communicates with the combustion chamber, and the blocking device may be formed so as to promote a circumferential direction flow or an axial direction flow in the combustion chamber the smaller the flow sectional area of the passage which communicates with the combustion chamber. The smaller the flow sectional area of the passage which communicates with the combustion chamber, the smaller the movement restricting device restricts the amount of movement of the interposed member and the larger the maximum pressure of the combustion chamber can be made.

In the present invention, the internal combustion engine may be an internal combustion engine in which a plurality of on-off valves are arranged for a single combustion chamber, wherein the engine is provided with a plurality of interposed members and a plurality of spring devices which are arranged corresponding to the plurality of on-off valves and the plurality of spring devices are formed so that the elastic forces become smaller the larger the total weights of the moving members which include the tapered plug parts and the interposed members.

In the present invention, the shaft-shaped part of the on-off valve may include a first valve shaft part which is connected to the tapered plug part and a second valve shaft part which is connected to the first valve shaft part through an elastic member, and the elastic member may have an elastic force by which it contracts corresponding to the amount of contraction of the spring device when the pressure of the combustion chamber reaches the control pressure and the spring device contracts and has an elastic force by which it does not contract when opening the on-off valve for opening the passage which communicates with the combustion chamber.

In the present invention, the internal combustion engine may be provided with a valve biasing member which biases the on-off valve in a direction by which the on-off valve closes, and the spring device may be arranged at the inside of the valve biasing member or at the outside so as to surround the valve biasing member.

In the present invention, the internal combustion engine may be provided with a cam for driving the on-off valve and a variable valve mechanism which changes a phase of the cam relative to a crank angle, the cam may have a recessed part which is formed so that the on-off valve can move during the time period while the spring device is contracted, and the variable valve mechanism may be used to change the phase of the recessed part of the cam so as to restrict the amount of movement of the on-off valve during the time period while the spring device is contracted.

In the present invention, the internal combustion engine may be provided with an electromagnetic drive device for driving the on-off valve, and the electromagnetic drive device may be driven during the time period while the pressure of the combustion chamber reaches the control pressure so as to adjust the pressure of the combustion chamber.

### Advantageous Effects of Invention

According to the present invention, it is possible to provide an internal combustion engine which suppresses the occurrence of abnormal combustion.

### BRIEF DESCRIPTION OF DRAWINGS

FIG. 1 is a schematic view of an internal combustion engine in Embodiment 1.

FIG. 2 is a schematic cross-sectional view of a first combustion pressure control device in Embodiment 1.

FIG. 3 is an enlarged schematic cross-sectional view of a stopper mechanism of a first stem of the first combustion pressure control device in Embodiment 1.

FIG. 4 is a schematic cross-sectional view of the time when a fluid spring is contracted in the first combustion pressure control device of Embodiment 1.

FIG. 5 is a view which explains the pressure of the combustion chamber and the amount of contraction of the fluid spring in an internal combustion engine which is provided with the combustion pressure control device of Embodiment 1.

FIG. 6 is a graph which explains a relationship between an ignition timing and an output torque in a comparative example.

FIG. 7 is a graph which explains a relationship between a crank angle and a pressure of a combustion chamber in a comparative example.

FIG. 8 is a graph which explains a relationship between a load of an internal combustion engine and a maximum pressure of the combustion chamber in a comparative example.

FIG. 9 is an enlarged view of a graph of the pressure of the combustion chamber when the pressure of the combustion chamber reaches a control pressure in the first combustion pressure control device of Embodiment 1.

FIG. 10 is a graph which explains a graph of the ignition timing of an internal combustion engine in Embodiment 1 and an internal combustion engine of a comparative example.

FIG. 11 is an enlarged schematic cross-sectional view of a connecting part of a first stem and a second stem of the second combustion pressure control device in the Embodiment 1.

FIG. 12 is a schematic cross-sectional view of a third combustion pressure control device in Embodiment 1.

FIG. 13 is a schematic cross-sectional view of a fourth combustion pressure control device in Embodiment 1.

FIG. 14 is a schematic cross-sectional view of a first combustion pressure control device in Embodiment 2.

FIG. 15 is a schematic perspective view of a movement restricting device and a blocking device of a first combustion pressure control device of Embodiment 2.

FIG. 16 is an explanatory view of the movement restricting device of the first combustion pressure control device in Embodiment 2.

FIG. 17 is a graph which explains a maximum pressure of a combustion chamber in an internal combustion engine which is provided with the first combustion pressure control device of Embodiment 2.

FIG. 18 is a graph which explains a relationship between a speed of an internal combustion engine and a knocking margin ignition timing in a comparative example.

FIG. 19 is a graph which explains a relationship between a speed and the maximum pressure of the combustion chamber of an internal combustion engine which is provided with the first combustion pressure control device in Embodiment 2.

FIG. 20 is a graph which explains a relationship between a concentration of alcohol which is contained in fuel and an amount of retardation correction in a comparative example.

FIG. 21 is a graph which explains a relationship between an alcohol concentration of fuel and the maximum pressure of a combustion chamber of an internal combustion engine which is provided with the first combustion pressure control device of Embodiment 2.

FIG. 22 is a schematic cross-sectional view of a combustion chamber, engine intake passage, and engine exhaust passage of an internal combustion engine which is provided with the first combustion pressure control device in Embodiment 2.

FIG. 23 is a schematic cross-sectional view of a combustion chamber, engine intake passage, and engine exhaust passage of another internal combustion engine which is provided with the first combustion pressure control device in Embodiment 2.

FIG. 24 is a schematic perspective view of a movement restricting device and a blocking device of a second combustion pressure control device of Embodiment 2.

FIG. 25 is a schematic cross-sectional view of an internal combustion engine which is provided with the second combustion pressure control device in Embodiment 2.

FIG. 26 is a schematic cross-sectional view of a first combustion pressure control device in Embodiment 3.

FIG. 27 is a schematic cross-sectional view of the part of an exhaust cam and the exhaust valve of the first combustion pressure control device in Embodiment 3.

FIG. 28 is a schematic view of a variable valve mechanism which changes the phase of a cam with respect to a crank angle in Embodiment 3.

FIG. 29 is a schematic cross-sectional view of an exhaust cam of the first combustion pressure control device in Embodiment 3.

FIG. 30 is a time chart of operational control of an internal combustion engine which is provided with the first combustion pressure control device in Embodiment 3.

FIG. 31 is a schematic perspective view of the part of an exhaust cam and the exhaust valve of a second combustion pressure control device in Embodiment 3.

FIG. 32 is a schematic cross-sectional view of a second exhaust cam of the second combustion pressure control device in Embodiment 3.

FIG. 33 is a schematic cross-sectional view of a cam switching device of the second combustion pressure control device in Embodiment 3.

FIG. 34 is another schematic cross-sectional view of a cam switching device of the second combustion pressure control device in Embodiment 3.

FIG. 35 is a graph of the pressure of the combustion chamber of an internal combustion engine which is provided with the second combustion pressure control device in Embodiment 3.

FIG. 36 is a schematic cross-sectional view of a combustion pressure control device in Embodiment 4.

FIG. 37 is a graph of the pressure of the combustion chamber of an internal combustion engine of a comparative example in Embodiment 4.

FIG. 38 is a time chart of first operational control of the combustion pressure control device in Embodiment 4.

FIG. 39 is a time chart of second operational control of the combustion pressure control device in Embodiment 4.

FIG. 40 is a time chart of third operational control of the combustion pressure control device in Embodiment 4.

### DESCRIPTION OF EMBODIMENTS

### Embodiment 1

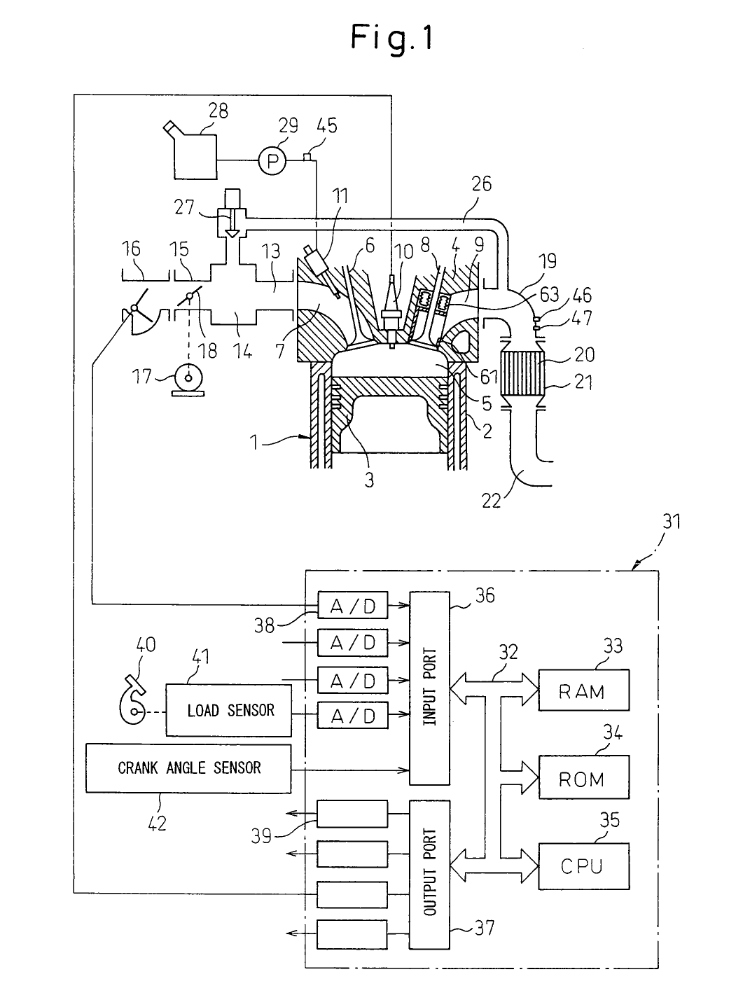

Referring to FIG. 1 to FIG. 13, an internal combustion engine in Embodiment 1 will be explained. In the present embodiment, the explanation will be given with reference to the example of an internal combustion engine which is mounted in a vehicle.

FIG. 1 is a schematic view of an internal combustion engine in the present embodiment. The internal combustion engine in the present embodiment is a spark ignition type. The internal combustion engine is provided with an engine body 1. The engine body 1 includes a cylinder block 2 and cylinder head 4. Inside the cylinder block 2, pistons 3 are arranged. Each piston 3 reciprocates inside of the cylinder block 2. In the present invention, the space inside the cylinder surrounded by the crown surface of the piston, the cylinder head, the intake valve, and the exhaust valve when the piston reaches compression top dead center and the space inside the cylinder surrounded by the crown surface of the piston at any position, the cylinder head, the intake valve, and the exhaust valve will be called the “combustion chamber”.

A combustion chamber 5 is formed for each cylinder. Each combustion chamber 5 is connected to an engine intake passage and an engine exhaust passage as passages which communicate with the combustion chamber. The engine intake passage is a passage for feeding the combustion chamber 5 with air or a mixture of fuel and air. The engine exhaust passage is a passage for discharging the exhaust gas which is produced by combustion of fuel in the combustion chamber 5. At the cylinder head 4, an intake port 7 and exhaust port 9 are formed.

The passages which communicate with the combustion chamber 5 are provided with on-off valves constituted by an intake valve 6 and exhaust valve 8. The intake valve 6 is arranged at an end of the intake port 7 and is formed to be able to open and close the engine intake passage which is communicated with the combustion chamber 5. The exhaust valve 8 is arranged at an end of the exhaust port 9 and is formed to be able to open and close the engine exhaust passage which is communicated with the combustion chamber 5. The on-off valves are supported by a support structure constituted by the cylinder head 4. At the cylinder head 4, a spark plug 10 serving as an ignition device is fastened. The spark plug 10 is formed to ignite the fuel in the combustion chamber 5.

The internal combustion engine in the present embodiment is provided with a fuel injector 11 for feeding fuel to each combustion chamber 5. The fuel injector 11 in the present embodiment is arranged so as to inject fuel to the intake port 7. The fuel injector 11 is not limited to this. It is sufficient that it be arranged to be able to feed fuel to the combustion chamber 5. For example, the fuel injector may be arranged so as to directly inject fuel to the combustion chamber.

The fuel injector 11 is connected to a fuel tank 28 through an electronic control type variable discharge fuel pump 29. The fuel which is stored in the fuel tank 28 is supplied to the fuel injector 11 by the fuel pump 29. In the middle of the flow path for feed of fuel, as a fuel property detecting device for detecting the properties of the fuel, a fuel property sensor 45 is arranged. For example, in an internal combustion engine which uses fuel which contains alcohol, a fuel property sensor 45 constituted by an alcohol concentration sensor is provided. The fuel property detecting device may also be arranged in the fuel tank.

The intake port 7 of each cylinder is connected through a corresponding intake runner 13 to a surge tank 14. The surge tank 14 is connected through an intake duct 15 and air flow meter 16 to an air cleaner (not shown). At the intake duct 15, the air flow meter 16 is arranged to detect the amount of intake air. At the inside of the intake duct 15, a throttle valve 18 which is driven by a step motor 17 is arranged. On the other hand, the exhaust port 9 of each cylinder is connected to a corresponding exhaust runner 19. The exhaust runner 19 is connected to a catalytic converter 21. The catalytic converter 21 in the present embodiment includes a three-way catalyst 20. The catalytic converter 21 is connected to an exhaust pipe 22. The engine exhaust passage is provided with a temperature sensor 46 for detecting the temperature of the exhaust gas.

The engine body 1 in the present embodiment has a recirculation passage for exhaust gas recirculation (EGR). In the present embodiment, as the recirculation passage, an EGR gas supply line 26 is arranged. The EGR gas supply line 26 connects an exhaust runner 19 and a surge tank 14 each other. The EGR gas supply line 26 is provided with an EGR control valve 27. The EGR control valve 27 is formed to enable the flow rate of the exhaust gas which is recirculated to be adjusted. If the ratio of the air and fuel (hydrocarbons) which are supplied to the engine intake passage, combustion chamber, or engine exhaust passage is referred to as the air-fuel ratio (A/F) of the exhaust gas, the engine exhaust passage at the upstream side of the catalyst converter 21 is provided with an air-fuel ratio sensor 47 for detecting the air-fuel ratio of the exhaust gas.

The internal combustion engine in the present embodiment is provided with an electronic control unit 31. The electronic control unit 31 in the present embodiment includes a digital computer. The electronic control unit 31 includes components connected to each other through a bidirectional bus 32 such as a RAM (random access memory) 33, ROM (read only memory) 34, CPU (microprocessor) 35, input port 36, and output port 37.

The air flow meter 16 generates an output voltage which is proportional to the amount of intake air which is taken into each combustion chamber 5. This output voltage is input to the input port 36 through a corresponding AD converter 38. An accelerator pedal 40 has a load sensor 41 connected to it. The load sensor 41 generates an output voltage which is proportional to the amount of depression of the accelerator pedal 40. This output voltage is input through a corresponding AD converter 38 to the input port 36. Further, a crank angle sensor 42 generates an output pulse every time a crankshaft for example turns by 30°. This output pulse is input to the input port 36. The output of the crank angle sensor 42 may be used to detect the engine speed. Furthermore, the electronic control unit 31 receives as input signals from the fuel property sensor 45, temperature sensor 46, air-fuel ratio sensor 47, and other sensors.

The output port 37 of the electronic control unit 31 is connected through corresponding drive circuits 39 to each fuel injector 11 and spark plug 10. The electronic control unit 31 in the present embodiment is formed so as to control fuel injection and control ignition. That is, the timing of injection of fuel and the amount of injection of fuel are controlled by the electronic control unit 31. Further the ignition timing of each spark plug 10 is controlled by the electronic control unit 31. Further, the output port 37 is connected through the corresponding drive circuits 39 to the step motor 17 for driving the throttle valve 18, the fuel pump 29, and the EGR control valve 27. These devices are controlled by the electronic control unit 31.

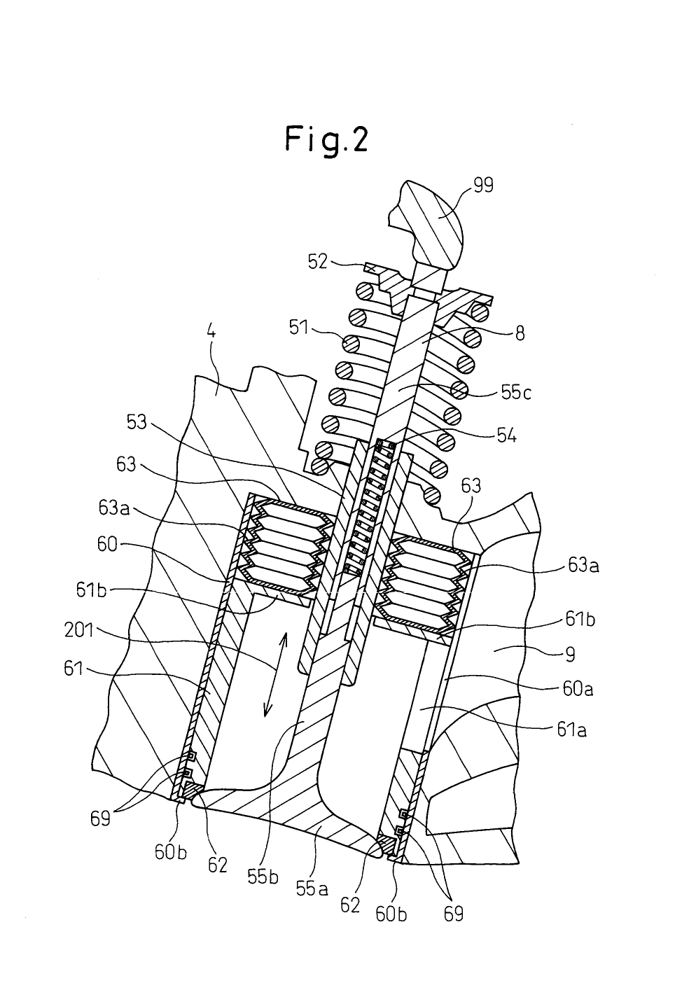

FIG. 2 shows an enlarged schematic cross-sectional view of a first combustion pressure control device in the present embodiment. The internal combustion engine in the present embodiment is provided with a combustion pressure control device which controls the pressure of the combustion chamber when fuel is burned. The combustion pressure control device in the present embodiment is arranged in a region at the inside of the passage which communicates with the combustion chamber where the on-off valve is arranged. The combustion pressure control device in the present embodiment is arranged in a region at the inside of the exhaust port 9 where the exhaust valve 8 is arranged.

The first combustion pressure control device in the present embodiment is provided with a frame member 60 which is arranged at the part of the exhaust port 9 which is connected to the combustion chamber 5. The frame member 60 in the present embodiment is formed into a cylinder. The frame member 60 is fastened to a support structure constituted by the cylinder head 4. The frame member 60 has an opening part 60a which forms the engine exhaust passage. The frame member 60 has an engaging part 60b. The engaging part 60b is arranged at an end part of the frame member 60 at the side which faces the combustion chamber. The engaging part 60b is formed so as to stick out to the inside of the frame member 60.

The first combustion pressure control device in the present embodiment is provided with an interposed member which is interposed between a tapered plug part 55a of the exhaust valve 8 and a later explained spring device. The interposed member in the present embodiment includes a tube-shaped member 61 which is formed into a tube shape. The tube-shaped member 61 is arranged at the inside of the frame member 60. The tube-shaped member 61 is formed to be able to slide with respect to the frame member 60. The tube-shaped member 61, as shown by the arrow 201, is formed to be able to move substantially parallel to the direction of movement of the exhaust valve 8. The end face of tube-shaped member 61 abuts against an engaging part 60b of the frame member 60, whereby the tube-shaped member 61 is prevented from being pulled out from the frame member 60.

The tube-shaped member 61 is open at one end part which faces the combustion chamber 5. Further, the tube-shaped member 61 has an opening part 61a at its side surface. The space at the inside of the tube-shaped member 61, the opening part 61a and the opening part 60a of the frame member 60 configure the engine exhaust passage. The exhaust gas is discharged through the space at the inside of the tube-shaped member 61 and the opening part 61a. At the outer circumferential surface of the tube-shaped member 61, a sealing member constituted by a seal ring 69 is arranged. The seal ring 69 is arranged along the circumferential direction of the tube-shaped member 61. The seal ring 69 keeps the gas of the combustion chamber 5 from passing through the clearance between the frame member 60 and the tube-shaped member 61 and leaking to the engine exhaust passage.

One end part of the tube-shaped member 61 engages with the tapered plug part 55a of the exhaust valve 8. The tube-shaped member 61 includes a valve seat 62 which is arranged at the part which contacts the tapered plug part 55a. The valve seat 62 keeps the gas of the combustion chamber 5 from leaking from the contact parts of the tapered plug part 55a and tube-shaped member 61. The tube-shaped member 61 has an abutting part 61b at the other end part at the side opposite to the open end part. The abutting part 61b abuts against the later explained fluid spring 63. In this way, the tube-shaped member 61 engages with the tapered plug part 55a at one end part and abuts against the fluid spring 63 at the other end part.

The tube-shaped member 61 is preferably formed from a material of a large strength and a small density so as to move in a direction substantially parallel to the direction of movement of the on-off valve as explained later. For example, it is preferably formed by titanium or aluminum. Due to this configuration, it is possible to maintain the strength while improving the response of the combustion pressure control device.

The combustion pressure control device in the present embodiment is provided with a spring device constituted by a fluid spring 63. The fluid spring 63 has elasticity by sealing a compressible fluid inside it. The fluid spring 63 of the present embodiment has air sealed inside the fluid sealing member. The fluid spring 63 in the present embodiment is formed into a ring shape. The fluid spring 63 is formed so as to surround a guide member 53. The fluid spring 63 in the present embodiment has a bellows part 63a and expands or contracts in the direction which is shown by the arrow 201 due to deformation of the bellows part 63a.

The fluid spring 63 is arranged between the tube-shaped member 61 and the cylinder head 4. The fluid spring 63 abuts against the cylinder head 4 at one end part. The fluid spring 63 abuts against the abutting part 61b of the tube-shaped member 61 at the other end part. The fluid spring 63 biases the tube-shaped member 61 to the side which faces the combustion chamber 5.

The exhaust valve 8 in the present embodiment is supported by the guide member 53. The guide member 53 in the present embodiment is formed to a tube shape. The guide member 53 is fastened to the cylinder head 4. The exhaust valve 8 is formed so as to slide through the inside of the guide member 53.

The exhaust valve 8 includes a tapered plug part 55a with a substantially circular shape when viewed by a plan view and a shaft-shaped part which is connected to the tapered plug part 55a. The shaft-shaped part in the present embodiment includes a first valve shaft part constituted by a first stem 55b which is connected to the tapered plug part 55a and a second valve shaft part at the side where the cam is arranged constituted by a second stem 55c. The first stem 55b and the second stem 55c are supported by the guide member 53.

At the front end part of the second stem 55c of the exhaust valve 8, a spring retainer 52 is fastened as a fastening member. Between the spring retainer 52 and the cylinder head 4, as a valve biasing member which biases the exhaust valve 8 in a direction by which the exhaust valve 8 closes, a valve spring 51 is arranged. The valve spring 51 biases the spring retainer 52 in a direction away from the combustion chamber 5. The front end part of the second stem 55c is pushed against the rocker arm 99. The rocker arm 99 is pushed by the exhaust cam. The internal combustion engine in the present embodiment uses the exhaust cam to push the rocker arm 99. Due to the rocker arm 99, the second stem 55c is pushed and the exhaust valve 8 opens.

The first stem 55b and the second stem 55c of the exhaust valve 8 are connected through an elastic member constituted by a coil spring 54. In the present embodiment, inside of the second stem 55c, a cavity part is formed. In this cavity part, the front end part of the first stem 55b is inserted. At the inside of the cavity part of the second stem 55c, the coil spring 54 is arranged. The coil spring 54 biases the first stem 55b and the second stem 55c in a direction by which the first stem 55b and the second stem 55c separate from each other.

The coil spring 54 is formed to have an elastic force of at least a strength so that when opening the exhaust valve 8 so as to open the engine exhaust passage which communicates with the combustion chamber 5, the first stem 55b and tapered plug part 55a move by being pushed by the second stem 55c. That is, the coil spring 54 is formed so that when the second stem 55c of the exhaust valve 8 is pushed by the exhaust cam or the rocker arm etc., the tapered plug part 55a moves toward the inside of the combustion chamber 5. Further, the coil spring 54 is formed so as to have an elastic force by which it is pushed by the first stem 55b and contracts corresponding to the amount of contraction of the fluid spring 63 when the fluid spring 63 contracts.

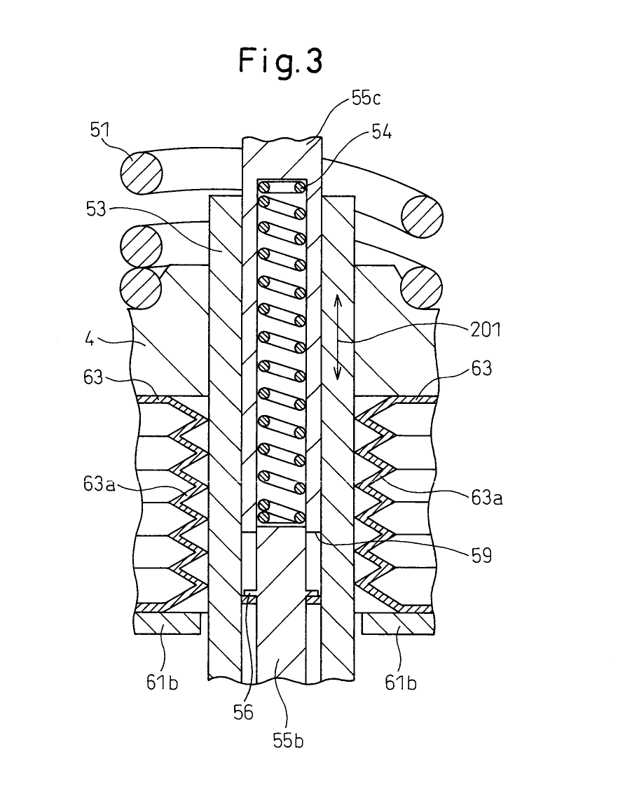

FIG. 3 shows another schematic cross-sectional view of the first combustion pressure control device in the present embodiment. FIG. 3 is a schematic cross-sectional view when cutting the part in FIG. 2 where the first stem and the second stem mate by another angle.

The exhaust valve 8 in the present embodiment has a stopper mechanism which prevents the first stem 55b from detaching from the second stem 55c. The stopper mechanism has a stopper part 56 which is formed at the first stem 55b. The stopper part 56 in the present embodiment is formed in a shaft shape. The stopper part 56 sticks out from the main body of the first stem 55b toward the outside. The stopper mechanism has a cutaway part 59 which is formed at the second stem 55c. The cutaway part 59 is formed in a direction of extension of the shaft-shaped part of the exhaust valve 8. The stopper part 56 is arranged at the inside of the cutaway part 59. The stopper part 56 is formed so as to enable movement inside of the cutaway part 59. By the stopper part 56 abutting against one end face of the cutaway part 59, the first stem 55b is prevented from detaching from the second stem 55c. Further, by the coil spring 54 expanding and contracting, the first stem 55b moves relative to the second stem 55c in the direction which is shown by the arrow 201. The stopper mechanism is not limited to this. Any mechanism which prevents the first stem from being detached from the second stem may be employed.

Referring to FIG. 2, when the pressure of the combustion chamber 5 is less than the control pressure, the tube-shaped member 61 engages with the engaging part 60b of the frame member 60 at the open end part due to the pressure of the fluid inside of the fluid spring 63. The tapered plug part 55a and the end face of the tube-shaped member 61 receive the pressure of the combustion chamber 5. In the compression stroke to the expansion stroke of the combustion cycle, when the pressure of the combustion chamber 5 becomes a predetermined control pressure or more, the fluid spring 63 contracts. That is, when the pushing force due to the pressure of the combustion chamber 5 becomes larger than the reaction force of the fluid spring 63, the fluid spring 63 contracts.

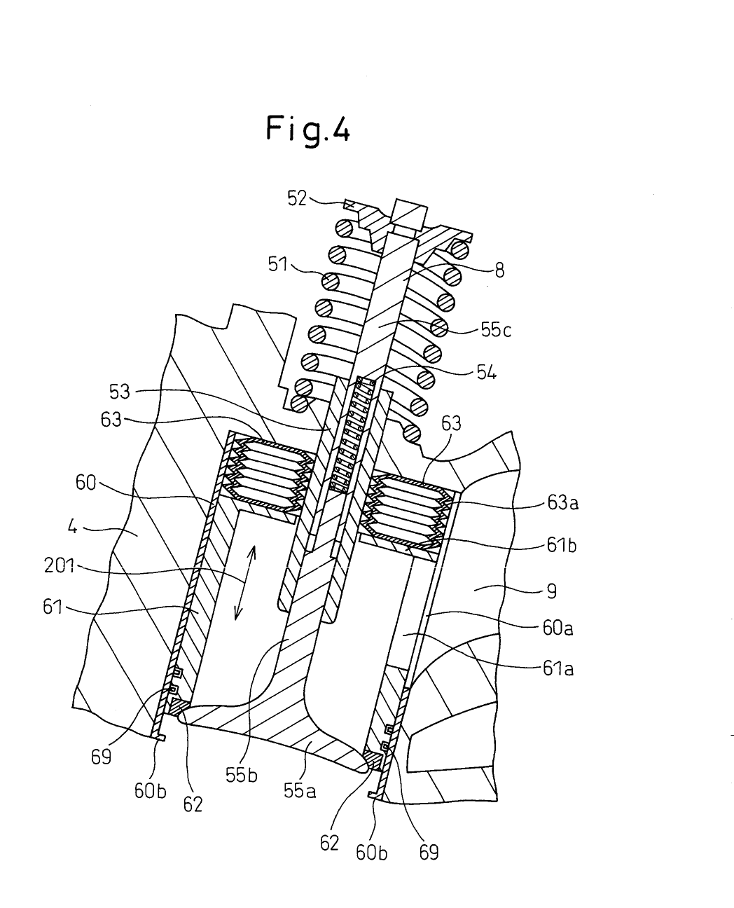

FIG. 4 shows a schematic cross-sectional view when the fluid spring contracts in the first combustion pressure control device of the present embodiment. Due to the fluid spring 63 contracting, the tube-shaped member 61, tapered plug part 55a, and first stem 55b move to the outside of the combustion chamber 5. In the present embodiment, the first stem 55b of the exhaust valve 8 pushes the coil spring 54. The coil spring 54 contracts whereby the first stem 55b moves relative to the second stem 55c. The tube-shaped member 61, tapered plug part 55a, and first stem 55b move to the opposite side from the side which faces the combustion chamber 5, whereby the volume of the combustion chamber 5 increases. For this reason, the pressure rise of the combustion chamber 5 can be suppressed.

When the combustion of the fuel in the combustion chamber 5 progresses and the pushing force due to the pressure of the combustion chamber 5 becomes smaller than the reaction force of the fluid spring 63, the fluid spring 63 expands. The tube-shaped member 61, tapered plug part 55a, and first stem 55b move toward the inside of the combustion chamber 5 and return to their original positions. Further, the volume of the combustion chamber 5 returns to its original magnitude.

In this way, in the combustion pressure control device in the present embodiment, when the pressure of the combustion chamber reaches the control pressure, the spring device expands and contracts. The spring device is formed so that the volume of the combustion chamber changes using the change of the pressure of the combustion chamber as a drive source. The control pressure in the present invention is the pressure of the combustion chamber when the spring device starts to change. At the inside of the fluid spring 63, a fluid of a pressure corresponding to the control pressure is sealed. The combustion pressure control device in the present embodiment determines the control pressure so that the pressure of the combustion chamber 5 does not become a pressure by which abnormal combustion occurs or more.

The abnormal combustion in the present invention, for example, includes combustion other than the state when an ignition device ignites the air-fuel mixture and the combustion successively propagates from the ignition point. Abnormal combustion includes, for example, the knocking phenomenon, detonation phenomenon, and preignition phenomenon. The knocking phenomenon includes the spark knock phenomenon. The spark knock phenomenon is the phenomenon where fuel is ignited in a spark device, the flame spreads centered from the ignition device, and the air-fuel mixture including unburned fuel at the position furthest from the ignition device self ignites. The air-fuel mixture at the position furthest from the ignition device is compressed by the combustion gas near the ignition device, becomes high temperature and high pressure, and self ignites. When the air-fuel mixture self ignites, a shock wave is generated.

The detonation phenomenon is the phenomenon where the air-fuel mixture ignites due to a shock wave passing through the high temperature and high pressure air-fuel mixture. This shock wave is, for example, generated due to the spark knock phenomenon.

The preignition phenomenon is also called the “early ignition phenomenon”. The preignition phenomenon is the phenomenon of metal at the tip of a spark plug or carbon sludge etc. deposited inside a combustion chamber being heated to a predetermined temperature or more and, in the state maintaining that, this part becoming the spark for ignition and burning of fuel before the ignition timing.

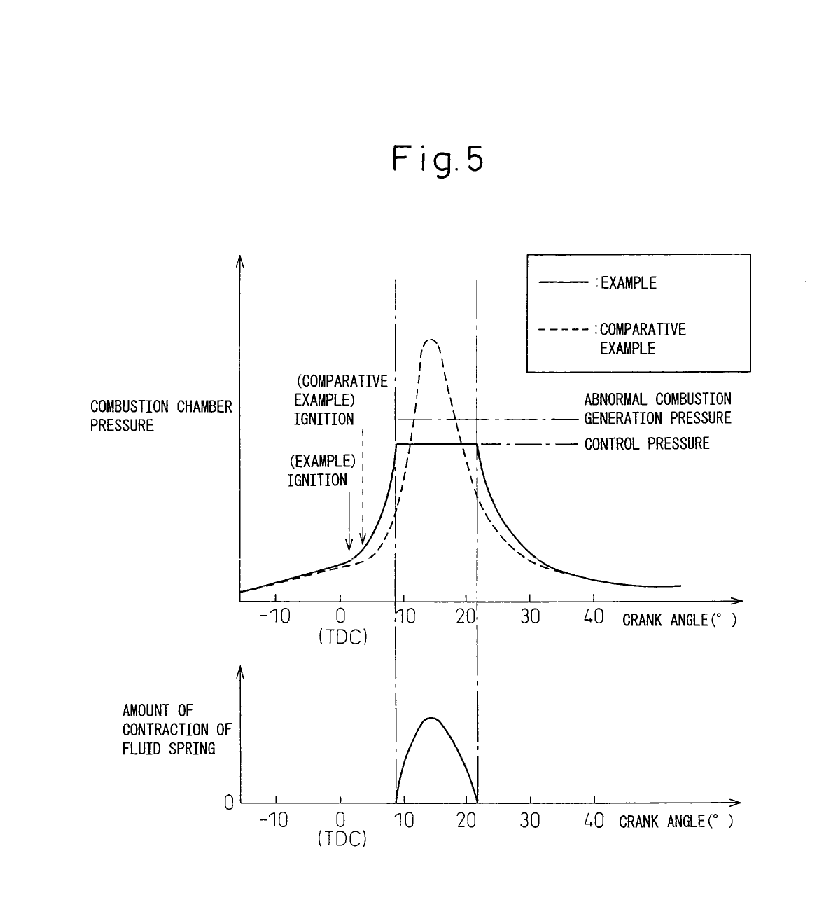

FIG. 5 shows a graph of the pressure of the combustion chamber in an internal combustion engine of the present embodiment. The abscissa indicates the crank angle, while the ordinate indicates the pressure of the combustion chamber and the amount of contraction of the fluid spring. FIG. 5 shows a graph of the compression stroke and the expansion stroke in the combustion cycle. The amount of contraction of the fluid spring 63 has a value of zero when one end part of the tube-shaped member 61 abuts against the engaging part 60b of the frame member 60.

Referring to FIG. 1, FIG. 2, FIG. 4, and FIG. 5, in the compression stroke, the piston 3 rises whereby the pressure of the combustion chamber 5 rises. Here, the fluid spring 63 has a fluid of a pressure corresponding to the control pressure sealed inside of it, so until the pressure of the combustion chamber 5 becomes the control pressure, the amount of contraction of the fluid spring 63 is zero. In the example which is shown in FIG. 5, the air-fuel mixture is ignited slightly after a crank angle of 0° (TDC). Due to the ignition, the pressure of the combustion chamber 5 rapidly rises. When the pressure of the combustion chamber 5 reaches the control pressure, the fluid spring 63 starts to contract. The tapered plug part 55a, the first stem 55b, and the tube-shaped member 61 of the exhaust valve 8 start to move relative to the frame member 60. When the combustion of the air-fuel mixture progresses, the amount of contraction of the fluid spring 63 becomes larger. For this reason, the rise in the pressure of the combustion chamber 5 is suppressed. In the example which is shown in FIG. 5, the pressure of the combustion chamber 5 is held substantially constant.

In the combustion chamber 5, when the combustion of fuel further progresses, the amount of contraction of the fluid spring 63 reaches the maximum, then becomes smaller. The pressure at the inside of the fluid spring 63 is reduced toward the original pressure and the amount of contraction of the fluid spring 63 returns to zero.

When the pressure of the combustion chamber 5 becomes less than the control pressure, the crank angle advances and the pressure of the combustion chamber 5 is decreased.

In this way, the combustion pressure control device in the present embodiment suppresses the rise in the pressure of the combustion chamber when the pressure of the combustion chamber 5 reaches the control pressure and controls the pressure of the combustion chamber so as not to become equal to or more than the pressure where abnormal combustion occurs.

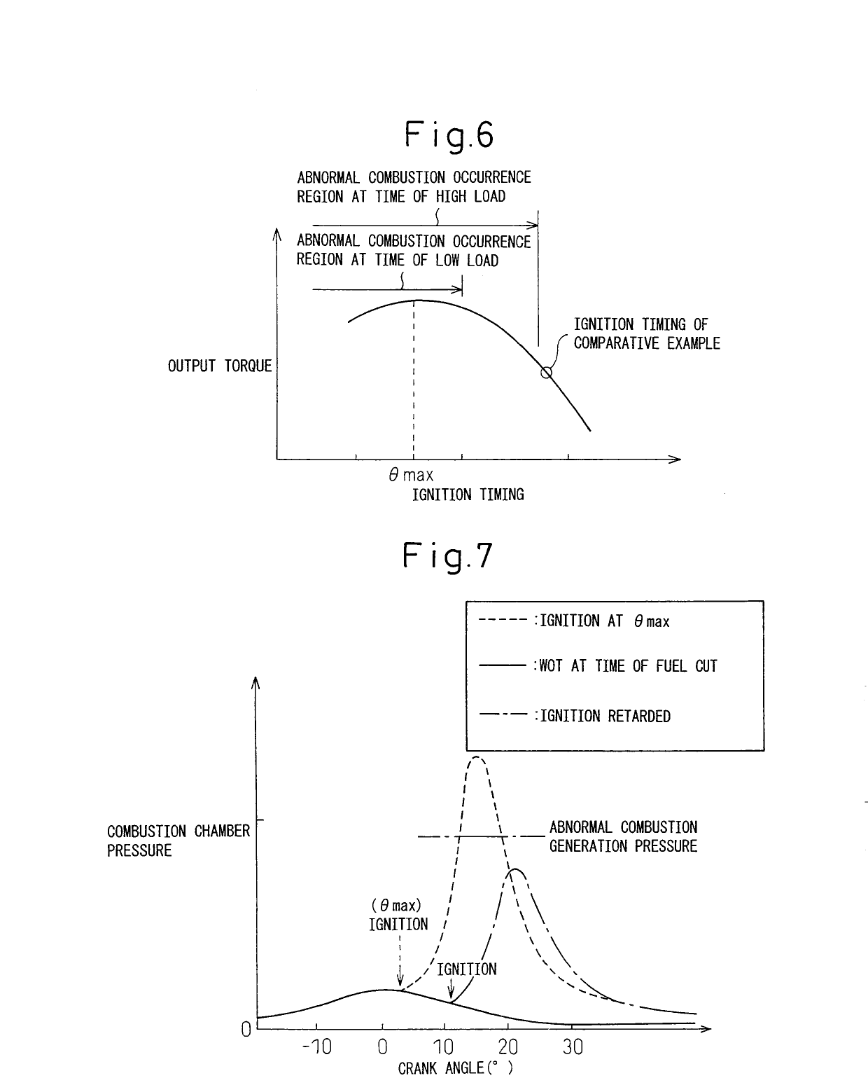

FIG. 6 is a graph which explains the relationship between the ignition timing and the output torque in an internal combustion engine of a comparative example in the present embodiment. The internal combustion engine of the comparative example does not have the combustion pressure control device in the present embodiment. That is, the internal combustion engine of the comparative example does not have the fluid spring 63 and tube-shaped member 61 etc. in the present embodiment. The exhaust valve stops from the compression stroke to the expansion stroke. Further, the shaft-shaped part of the exhaust valve 8 is formed integrally. The graph of FIG. 6 is a graph when the internal combustion engine of the comparative example is being operated under a predetermined state. The abscissa indicates the crank angle (ignition timing) at the time of ignition.

It is learned that the performance of an internal combustion engine changes depending on the timing of ignition of the air-fuel mixture. An internal combustion engine has an ignition timing (θmax) where the output torque becomes maximum. The ignition timing where the output torque becomes maximum changes depending on the engine speed, throttle opening degree, air-fuel ratio, compression ratio, etc. By ignition at the ignition timing where the output torque becomes maximum, the pressure of the combustion chamber becomes higher and the heat efficiency becomes the best. Further, the output torque becomes larger and the amount of fuel consumption can be reduced. Further, the carbon dioxide which is exhausted can be decreased.

In this regard, if making the ignition timing earlier, the knocking phenomenon and other abnormal combustion occurs. In particular, if becoming a high load, the region where abnormal combustion occurs becomes larger. In the internal combustion engine of the comparative example, to avoid abnormal combustion, ignition is performed retarded from the ignition timing (θmax) where the output torque becomes maximum. In this way, an ignition timing avoiding the region where abnormal combustion occurs is selected.

FIG. 7 shows a graph of the pressure of the combustion chamber of the internal combustion engine of the comparative example. The solid line shows the pressure of the combustion chamber when stopping the feed of fuel (fuel cut) and the opening degree of the throttle valve is wide open (WOT). The pressure of the combustion chamber at this time becomes maximum when the crank angle is 0°, that is, at compression top dead center. This pressure becomes the maximum pressure of the combustion chamber when not feeding fuel.

In an internal combustion engine, the pressure of the combustion chamber fluctuates depending on the ignition timing. The graph which is shown by the broken line is a graph of ignition at the ignition timing where the output torque becomes maximum. The broken line shows the case of assuming abnormal combustion does not occur. In the example which is shown in FIG. 7, the air-fuel mixture is ignited at a timing of the crank angle slightly after 0° (TDC). In the case of ignition at the ignition timing where the output torque becomes maximum, the pressure of the combustion chamber becomes higher. However, in an actual internal combustion engine, the maximum pressure of the combustion chamber (Pmax) becomes larger than the pressure at which abnormal combustion occurs, so the ignition timing is retarded. The one-dot chain line is a graph when retarding the ignition timing. When retarding the ignition timing, the maximum pressure of the combustion chamber becomes smaller than the case of ignition at the ignition timing where the output torque becomes maximum.

Referring to FIG. 5, the broken line shows the graph of the case of ignition at the ignition timing (θmax) where the output torque becomes maximum in the internal combustion engine of the comparative example. As explained above, in the case of ignition at this ignition timing, abnormal combustion occurs.

As opposed to this, the internal combustion engine in the present embodiment can burn fuel so that the maximum pressure of the combustion chamber becomes less than the pressure of occurrence of abnormal combustion. Even if advancing the ignition timing, the occurrence of abnormal combustion can be suppressed. In particular, even in an engine with a high compression ratio, abnormal combustion can be suppressed. For this reason, compared with the internal combustion engine of the comparative example which retards the ignition timing shown in FIG. 7, the heat efficiency is improved and the output torque can be increased. Alternatively, the amount of fuel consumption can be reduced.

Referring to FIG. 5, in the internal combustion engine of the present embodiment, ignition is performed at the ignition timing giving the best heat efficiency. The internal combustion engine of the present embodiment also enables ignition at the ignition timing where the output torque becomes maximum of the internal combustion engine of the comparative example. However, the internal combustion engine in the present embodiment advances the ignition timing over the ignition timing where the output torque becomes maximum of the internal combustion engine of the comparative example. Due to this configuration, it is possible to further improve the heat efficiency and further increase the output torque. In this way, the internal combustion engine in the present embodiment avoids abnormal combustion while enabling ignition at the timing when the heat efficiency becomes the best.

In the present embodiment, the sealing pressure of the fluid inside of the fluid spring 63 becomes higher than the control pressure. The control pressure can be made larger than the maximum pressure of the combustion chamber when stopping the feed of fuel. That is, it is possible to set it larger than the maximum pressure of the combustion chamber of the graph of the solid line which is shown in FIG. 7. Further, the control pressure can be set to less than the pressure at which abnormal combustion occurs.

In the internal combustion engine of the comparative example, to retard the ignition timing, the temperature of the exhaust gas becomes higher. Alternatively, the heat efficiency is low, so the temperature of the exhaust gas becomes higher. In the internal combustion engine of the comparative example, to lower the temperature of the exhaust gas, sometimes the air-fuel ratio at the time of combustion is made smaller than the stoichiometric air-fuel ratio. In this regard, the exhaust purification device constituted by the three-way catalyst exhibits a high purification ability when the air-fuel ratio of the exhaust gas is near the stoichiometric air-fuel ratio. The three-way catalyst ends up becoming extremely small in purification performance if off from the stoichiometric air-fuel ratio. For this reason, if making the air-fuel ratio at the time of combustion smaller than the stoichiometric air-fuel ratio, the exhaust gas purification ability ends up falling and the unburned fuel etc. which are contained in the exhaust gas end up becoming greater. Further, in the internal combustion engine of the comparative example, the temperature of the exhaust gas becomes higher, so sometimes heat resistance of the exhaust purification device is demanded and high quality materials become required or a device for cooling the exhaust gas or new structure for cooling the exhaust gas becomes necessary.

As opposed to this, in the internal combustion engine in the present embodiment, the heat efficiency is high, so the temperature of the exhaust gas can be kept from becoming high. In the internal combustion engine in the present embodiment, there is little need for reducing the air-fuel ratio at the time of combustion so as to lower the temperature of the exhaust gas. When the exhaust purification device includes a three-way catalyst, the purification performance can be maintained. Furthermore, the temperature of the exhaust gas can be kept from becoming higher, so there is less of a demand for heat resistance of the members of the exhaust purification device. Alternatively, it is possible to form the system even without newly adding a device for cooling the exhaust gas etc.

Further, referring to FIG. 5, in general, when raising the compression ratio of the internal combustion engine to improve the heat efficiency, the maximum pressure Pmax of the combustion chamber becomes larger. For this reason, it is necessary to increase the strength of the members which form the internal combustion engine. However, in the internal combustion engine in the present embodiment, the maximum pressure of the combustion chamber can be kept from becoming greater and the components can be kept from become larger. For example, the diameter of the connecting rod can be kept from becoming larger. Further, the friction between components can be kept from being larger and deterioration of the fuel efficiency can be suppressed.

Furthermore, there is the problem that when the maximum pressure of the combustion chamber is high, increasing the diameter of the combustion chamber is difficult. If the diameter of the combustion chamber becomes larger, it becomes necessary to increase the strength of the support parts of the piston and other components. However, in the present embodiment, since it is possible to maintain the maximum pressure of the combustion chamber low, it is possible to keep the demanded strength of the components low. For this reason, the diameter of the combustion chamber can easily be increased.

Next, the control pressure in the combustion pressure control device of the internal combustion engine of the present embodiment will be explained.

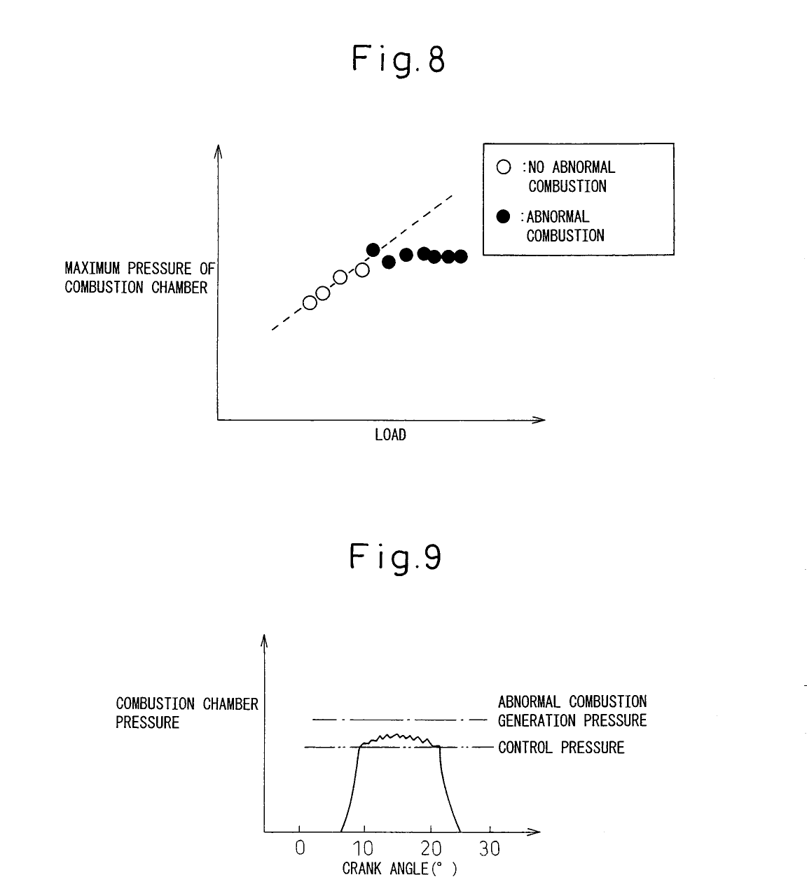

FIG. 8 is a graph which shows the relationship between the load in an internal combustion engine of a comparative example and the maximum pressure in the combustion chamber. The load of an internal combustion engine corresponds to the amount of injection of fuel in the combustion chamber. When abnormal combustion does not occur, as shown by the broken line, as the load increases, the maximum pressure of the combustion chamber increases. If becoming larger than a predetermined load, abnormal combustion occurs. It is learned that the maximum pressure of the combustion chamber when abnormal combustion occurs is substantially constant without regard as to the load.

In the internal combustion engine of the present embodiment, the control pressure is set so that the pressure of the combustion chamber does not reach a pressure at which abnormal combustion occurs. As the control pressure, a large pressure in the range where the maximum pressure of the combustion chamber at the time of combustion of the fuel becomes smaller than the pressure where abnormal combustion occurs is preferable. The control pressure is preferably raised to near the pressure at which abnormal combustion occurs. By this configuration, the abnormal combustion can be suppressed while the heat efficiency is increased.

FIG. 9 shows another graph of the pressure of the combustion chamber of the internal combustion engine in the present embodiment. FIG. 9 is an enlarged view of the part where the pressure of the combustion chamber reaches the control pressure. Referring to FIG. 4 and FIG. 9, in the internal combustion engine of the present embodiment, when the pressure of the combustion chamber reaches the control pressure, the tube-shaped member 61, tapered plug part 55a, and first stem 55b move relative to the frame member 60. At this time, sometimes the fluid spring 63 contracts and the pressure at the inside of the fluid spring 63 rises. For this reason, sometimes the pressure of the combustion chamber 5 rises along with the rise of pressure at the inside of the fluid spring 63. The graph of the pressure of the combustion chamber 5 becomes a shape projecting upward. When setting the control pressure, it is preferable to set it low in anticipation of the amount of rise of the pressure inside the fluid spring 63 so that the maximum pressure of the combustion chamber 5 does not reach the pressure where abnormal combustion occurs.

Next, the ignition timing of the internal combustion engine of the present embodiment will be explained.

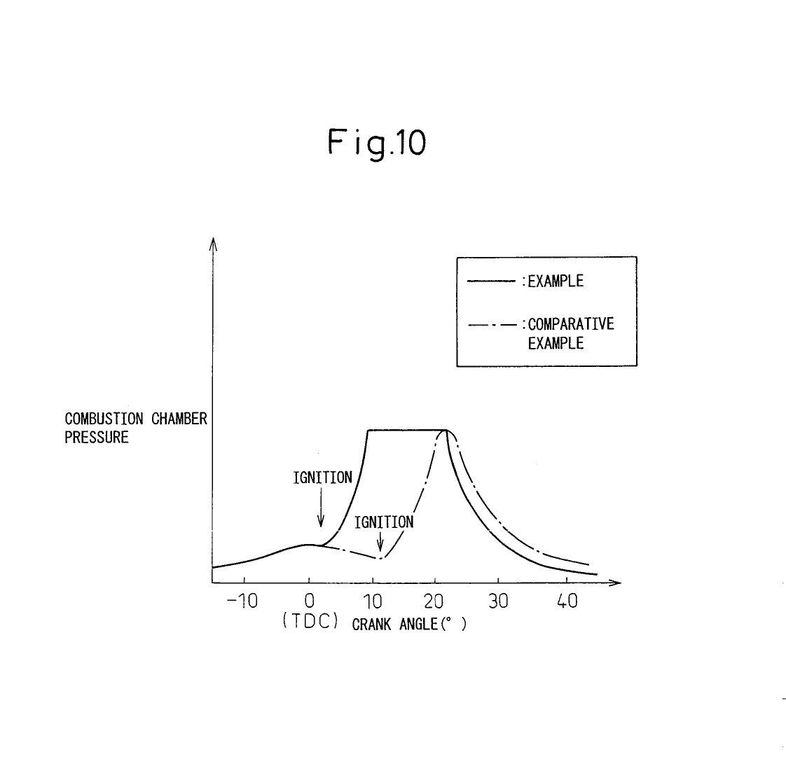

FIG. 10 is a graph of the pressure of the combustion chamber in internal combustion engines of the present embodiment and the comparative example. The solid line shows a graph of ignition at the timing when the output torque becomes maximum in the internal combustion engine of the present embodiment. The one-dot chain line shows a graph of the case of regarding the ignition timing in the internal combustion engine of the comparative example.

The internal combustion engine in the present embodiment, as explained above, preferably selects the ignition timing θmax where the heat efficiency of the internal combustion engine becomes maximum. However, the pressure of the combustion chamber at this ignition timing becomes higher. For example, the pressure of the combustion chamber at the ignition timing of the present embodiment becomes larger than the pressure of the combustion chamber at the ignition timing of the comparative example. For this reason, depending on the internal combustion engine, sometimes sparks do not fly and misfire ends up occurring. In particular, in the internal combustion engine of the present embodiment, ignition is performed at a crank angle near 0° (TDC). At a crank angle near 0°, the pressure of the combustion chamber is high, so sparks have difficulty flying. That is, the air density is high, so electrodischarge does not easily occur.

Referring to FIG. 1, if misfire occurs in the combustion chamber 5, the unburned fuel passes through the engine exhaust passage and flows into the exhaust purification device. In the present embodiment, the unburned fuel passes through the exhaust port 9 and flows into the three-way catalyst 20. In this case, sometimes the unburned fuel which flows into the three-way catalyst 20 becomes greater and the properties of the exhaust gas which is discharged into the atmosphere deteriorate. Alternatively, at the three-way catalyst 20, sometimes the unburned fuel burns and the three-way catalyst 20 becomes excessively hot.

Referring to FIG. 10, in an internal combustion engine which is susceptible to such misfire, the ignition timing can be advanced. That is, the ignition timing can be made earlier. For example, the ignition timing can be made to further advance over the ignition timing where the output torque becomes maximum. By making the ignition timing earlier, ignition is possible when the pressure of the combustion chamber is low and misfires can be suppressed.

Referring to FIG. 2, the combustion pressure control device in the present embodiment arranges a tube-shaped member which can move in the direction of movement of the on-off valve inside of the passage which communicates with the combustion chamber. That is, part of the combustion pressure control device can be arranged in the engine intake passage or the engine exhaust passage. For this reason, the volume of the combustion chamber can be kept from becoming smaller or the diameter of the tapered plug part of the intake valve or the exhaust valve can be kept from being made smaller while the combustion pressure control device can be connected to the combustion chamber.

Further, the combustion pressure control device in the present embodiment comprises the tapered plug part of the on-off valve, tube-shaped member, or other moving members which are adjacent to the combustion chamber. These moving members are directly subjected to the pressure of the combustion chamber. Furthermore, the moving members include the tapered plug part, so the area of the parts of the moving members which contact the combustion chamber becomes larger. For this reason, the amount of movement of the tube-shaped member and other moving members can be made smaller. It is therefore possible to provide the combustion pressure control device with an excellent response.

In the present embodiment, the coil spring 54 which is interposed between the first stem 55b and the second stem 55c is formed so as to contract corresponding to the amount of contraction of the fluid spring 63 when the fluid spring 63 contracts. In this regard, if the coil spring 54 becomes too small in elastic force, when opening the exhaust valve 8, sometimes the inertia of the tapered plug part 55a and the first stem 55b will cause a delay in the timing when the tapered plug part 55a starts to move. For this reason, the coil spring 54 preferably has a large elastic force so that the movement of the tapered plug part 55a does not become delayed when opening the on-off valve. The coil spring 54 preferably has an elastic force whereby the tapered plug part 55a and the first stem 55b start to move simultaneously with the second stem 55c. The coil spring 54 preferably has an elastic force whereby it does not contract when opening the on-off valve. By adopting this configuration, it is possible to avoid delayed operation of the on-off valve.

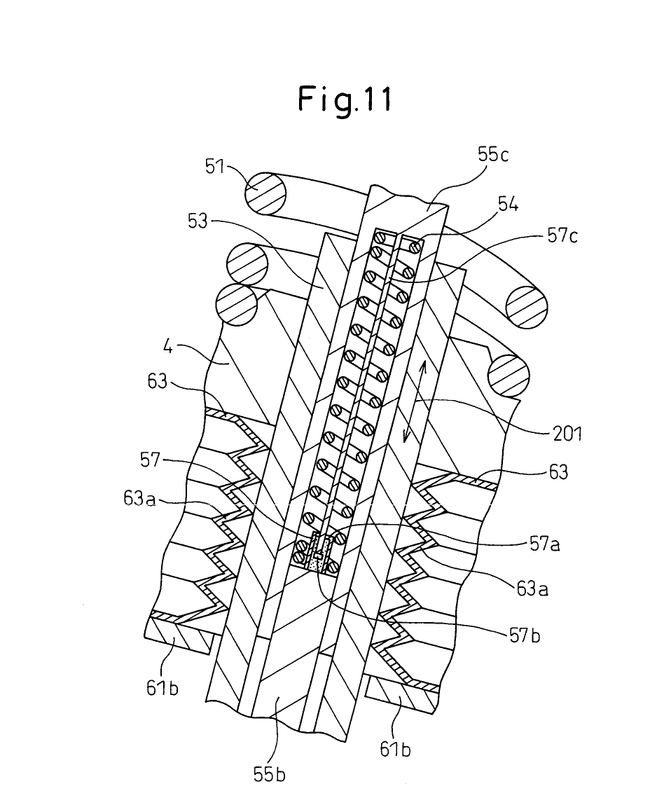

FIG. 11 shows an enlarged schematic cross-sectional view of the second combustion pressure control device in the present embodiment. FIG. 11 is an enlarged schematic cross-sectional view of a mating part of the first stem and the second stem of the exhaust valve. In the second combustion pressure control device in the present embodiment, the first stem 55b and the second stem 55c are connected through a damper 57. The damper 57 in the present embodiment is arranged at the inside of the coil spring 54.

The damper 57 in the present embodiment includes a container 57a. The container 57a is fastened to the first stem 55b. At the inside of the container 57a, a fluid is sealed. In the present embodiment, the inside of the container 57a is filled with oil. The damper 57 has a plate member 57b which is formed to be able to move at the inside of the container 57a. The plate member 57b is formed so that oil passes around it. The damper 57 has a supporting member 57c which is fastened to the second stem 55c. The supporting member 57c is formed into a shaft shape. The supporting member 57c supports the plate member 57b.

By arranging the damper 57 between the first stem 55b and the second stem 55c, resonance of the exhaust valve 8 can be suppressed. When the natural frequencies of the tapered plug part 55a, the first stem 55b, and the coil spring 54 match the frequency of vibration which occurs depending on the speed of internal combustion engine and resonance occurs, the amplitude of the vibration can be made smaller. Further, along with the opening and closing operation of the exhaust valve, sometimes the first stem 55b ends up vibrating with respect to the second stem 55c. The damper 57 can reduce the amplitude of such vibration.

The damper in the present embodiment is an oil damper, but the invention is not limited to this. Any damper which suppresses vibration of the first stem, tapered plug part, coil spring, etc. may be interposed between the first stem and the second stem.

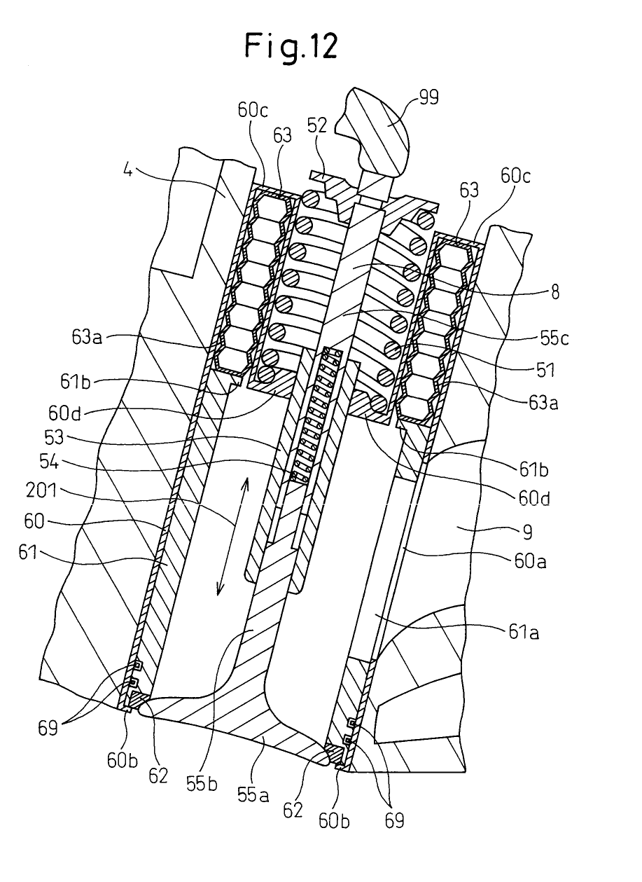

FIG. 12 shows a schematic cross-sectional view of a third combustion pressure control device in the present embodiment. In the third combustion pressure control device, the fluid spring 63 is arranged at the outside of the valve spring 51 as the valve biasing member. The fluid spring 63 is formed in a ring shape. The fluid spring 63 is formed so as to surround the valve spring 51.

The frame member 60 of the third combustion pressure control device is fastened to the cylinder head 4. The frame member 60 extends to the side of the valve spring 51. The frame member 60 has a support part 60c for supporting an end part of the fluid spring 63. The frame member 60 has a support part 60d for supporting an end part of the valve spring 51. The guide member 53 which supports the first stem 55b and the second stem 55c are fastened to the support part 60d of the frame member 60. The tube-shaped member 61 of the third combustion pressure control device has an abutting part 61b which abuts against the fluid spring 63.

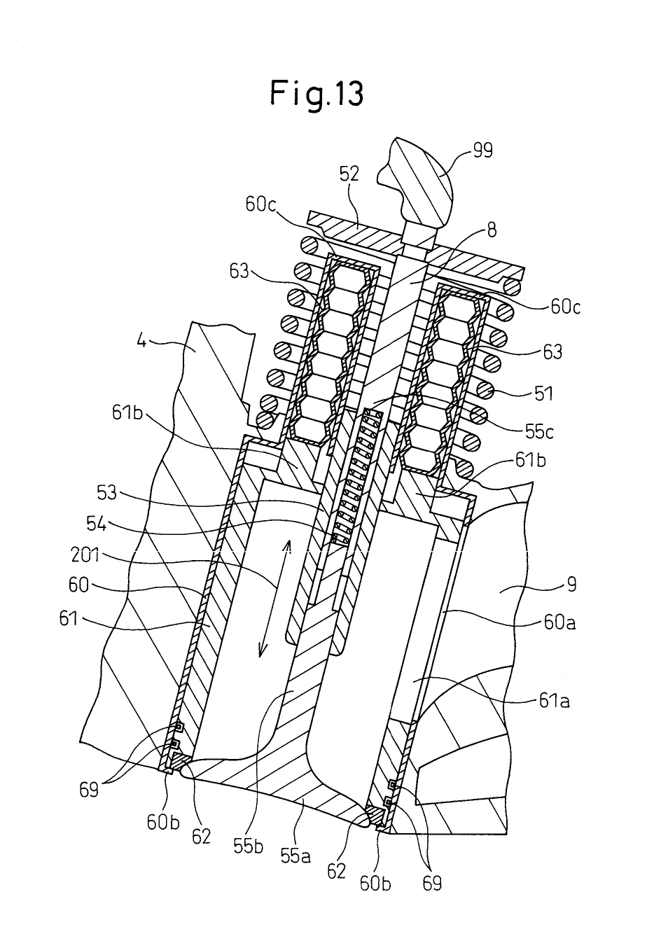

FIG. 13 shows a schematic cross-sectional view of a fourth combustion pressure control device in the present embodiment. In the fourth combustion pressure control device, the fluid spring 63 is arranged at the inside of the valve spring 51. The fluid spring 63 is formed at the ring shape. The valve spring 51 is formed so as to surround the fluid spring 63.

The frame member 60 of the fourth combustion pressure control device is fastened to the cylinder head 4. The frame member 60 extends at the inside of the valve spring 51. The frame member 60 has a support part 60c for supporting an end part of the fluid spring 63. The guide member 53 is fastened to a front end of the support part 60c. The tube-shaped member 61 of the fourth combustion pressure control device has an abutting part 61b which abuts against the fluid spring 63.

In the third combustion pressure control device, the fluid spring 63 is arranged at the outside of the valve spring 51, while in the fourth combustion pressure control device, the fluid spring 63 is arranged at the inside of the valve spring 51. That is, the fluid spring 63 and the valve spring 51 are formed in ring shapes and are arranged in a double structure. By adopting this configuration, it is possible to increase the length of the fluid spring 63 in the direction of movement of the exhaust valve 8. It is possible to increase the amount of contraction of the fluid spring 63 and increase the length of movement when the tube-shaped member 61, tapered plug part 55a, and first stem 55b move.

Further, it is possible to enlarge the opening part 61a of the tube-shaped member 61 and the opening part 60a of the frame member 60. For example, it is possible to make the lengths of the opening parts 60a and 61a in the movement direction of the on-off valves longer than the first combustion pressure control device in the present embodiment. It is possible to make the flow sectional area of the passage which communicates with the combustion chamber larger and possible to reduce the pressure loss. For example, the intake loss and exhaust loss etc., called “the pumping loss”, can be made smaller.

When arranging the third combustion pressure control device or the fourth combustion pressure control device in the present embodiment at the exhaust valve side, the fluid spring 63 can be arranged at the outside of the engine exhaust passage. For this reason, it is possible to keep the heat of the exhaust gas from causing a rise in temperature of the fluid at the inside of the fluid spring 63. It is possible to keep the sealing pressure at the inside of the fluid spring 63 from changing. As a result, it is possible to keep the control pressure from changing.

In the third combustion pressure control device or the fourth combustion pressure control device in the present embodiment, the end part of the fluid spring 63 and the end part of the valve spring 51 are supported by the frame member 60, but the invention is not limited to this. They may also be supported by a support structure constituted by the cylinder head 4.

The combustion pressure control device which is explained in the present embodiment is arranged in the region where the exhaust valve is arranged, but the invention is not limited to this. It may also be arranged in the region in which the intake valve is arranged. For example, it is also possible to arrange the tube-shaped member at the entry part to the combustion chamber of the intake port and to arrange a fluid spring between the tube-shaped member and the cylinder head. For the intake valve as well, in the same way as the exhaust valve in the present embodiment, the shaft-shaped part may include a first stem and a second stem and the first stem and the second stem may be connected through an elastic member.

In the present embodiment, the explanation was given for a combustion pressure control device which arranges a tube-shaped member etc. for a single valve, but when a plurality of on-off valves are arranged for a single combustion chamber, it is possible to arrange tube-shaped members etc. for the respective on-off valves. That is, it is possible to arrange a plurality of tube-shaped members, a plurality of fluid springs, etc. for a single combustion chamber.

In this regard, in an internal combustion engine where a plurality of on-off valves are arranged for a single combustion chamber and where tube-shaped members, fluid springs, etc. are arranged for the plurality of on-off valves, sometimes the weights of the members which move when the pressure of the combustion chamber reaches the control pressure differ from each other.

For example, sometimes the diameter of the tapered plug part of the intake valve is larger than the diameter of the tapered plug part of the exhaust valve. In an internal combustion engine which is provided with such an intake valve and the exhaust valve, when tube-shaped members, fluid springs, etc. are provided at both the intake valve side and the exhaust valve side, sometimes the responses differ in accordance with the total weights of the members which move when the pressure of the combustion chamber reaches the control pressure. The moving members are members which change in position when the fluid spring 63 contracts and, for example, include the tube-shaped member 61, tapered plug part 55a, and first stem 55b. The greater the total weight of the moving members, the slower the response in movement with respect to a rise in pressure of the combustion chamber 5.

When the total weights of the moving members which are arranged corresponding to the on-off valves differ, the larger the total weight of the moving members, the smaller the elastic force can be set for the spring device. When the spring device includes a fluid spring 63, the larger the total weight of the moving members, the smaller the pressure can be made at the inside of the fluid spring 63. For example, the larger the total weight of the tapered plug part 55a and first stem 55b of the on-off valve and the tube-shaped member 61, the smaller the pressure can be made at the inside of the fluid spring 63. By employing this configuration, it is possible to improve the response of the combustion pressure control device of the heavy total weight of the moving members. When arranging a plurality of tube-shaped members, fluid springs, etc. for a single combustion chamber, the responses of movement of the members can be made substantially the same.

For example, when the diameter of the tapered plug part of the intake valve is larger than the diameter of the tapered plug part of the exhaust valve, the sealing pressure of the fluid spring which is arranged at the intake valve side can be made smaller than the sealing pressure of the fluid spring which is arranged at the exhaust valve side. Alternatively, depending on the type of the internal combustion engine, sometimes the total weight of the members which move at the exhaust valve side is heavier than the total weight of the members which move at the intake valve side. In this case, it is possible to make the sealing pressure of the fluid spring at the exhaust valve side smaller than the sealing pressure of the fluid pressure at the intake valve side. In this way, it is possible to adjust the pressure inside of a fluid spring in accordance with the total weight of the moving members of the combustion pressure control devices which are formed corresponding to the respective on-off valves.

The spring device in the present embodiment includes a fluid spring, but the invention is not limited to this. The spring device may be made any device which can apply a biasing force which corresponds to the control pressure to the interposed member. For example, the spring device may also include a mechanical spring such as a coil spring. Further, when the spring device includes a fluid spring, it is possible to connect a pressure regulating device which regulates the pressure at the inside of the fluid spring to the fluid spring. By changing the pressure at the inside of the fluid spring, the control pressure can be adjusted.

The interposed member in the present embodiment includes a tube-shaped member which is formed into a tubular shape, but the invention is not limited to this. The interposed member may be made a member of any structure so long as it is formed to be able to move in a direction substantially parallel to the direction of movement of the on-off valve, one end part engages with the tapered plug part of the on-off valve, and the other end part abuts against the fluid spring. For example, the interposed member may have a structure where the part which engages with the tapered plug part of the on-off valve and the part which pushes against the fluid spring are coupled by a shaft-shaped member.

### Embodiment 2

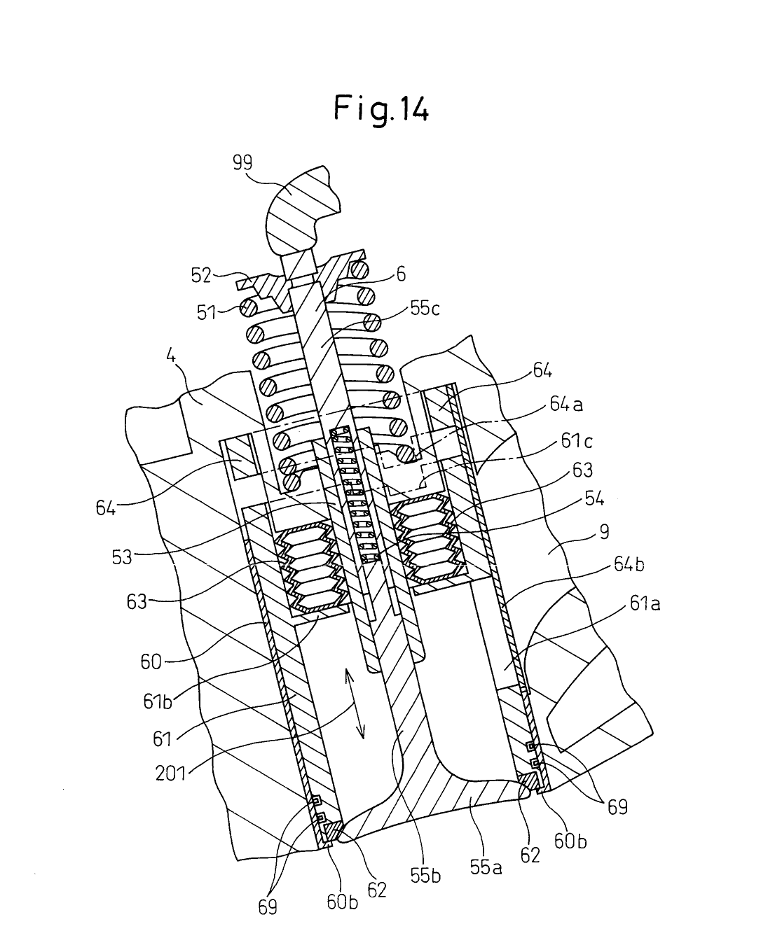

Referring to FIG. 14 to FIG. 25, the internal combustion engine in Embodiment 2 will be explained. The internal combustion engine in the present embodiment is provided with the combustion pressure control device.

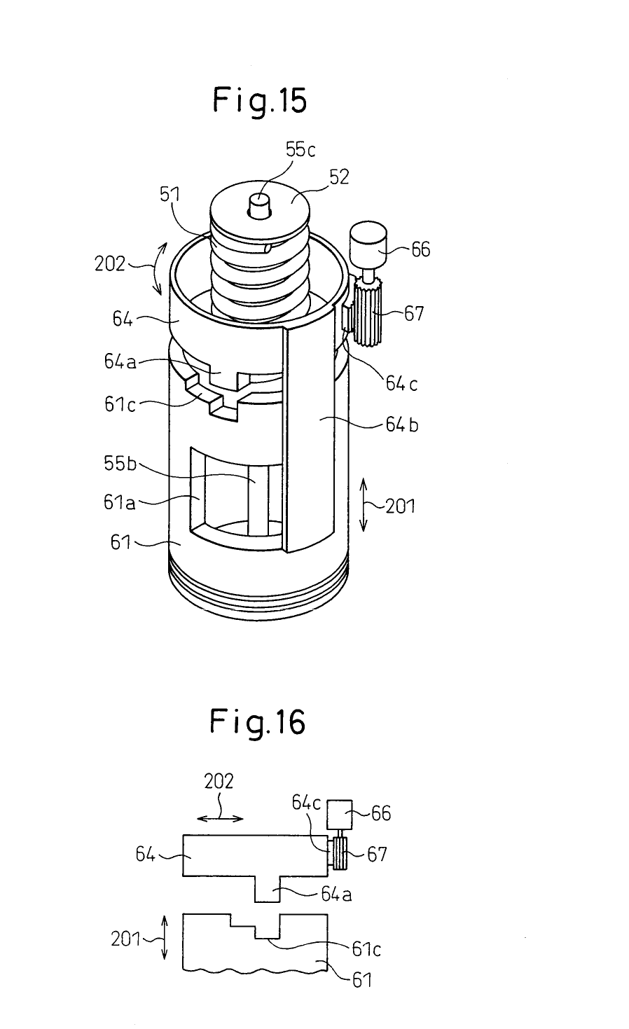

FIG. 14 is a schematic cross-sectional view of a first combustion pressure control device in the present embodiment. FIG. 15 is a schematic perspective view of a tube-shaped member and pipe-shaped member of the first combustion pressure control device in the present embodiment. The combustion pressure control device in the present embodiment is arranged in the region where the intake valve is arranged.

Referring to FIG. 14 and FIG. 15, the combustion pressure control device in the present embodiment is provided with a movement restricting device which restricts the amount of movement of the tube-shaped member 61. The movement restricting device in the present embodiment includes a pipe-shaped member 64 as a movement restricting member. The pipe-shaped member 64 in the present embodiment is formed in a cylindrical shape. The pipe-shaped member 64 is arranged while facing the tube-shaped member 61. The pipe-shaped member 64 has a projecting part 64a which projects out toward the tube-shaped member 61. The pipe-shaped member 64 abuts against the cylinder head 4 at the end at the opposite side to the side which faces the tube-shaped member 61. The pipe-shaped member 64 is formed so as not to move to the opposite side from the side which faces the tube-shaped member 61.

The tube-shaped member 61 in the present embodiment is formed so as to extend beyond the region where the fluid spring 63 is arranged. At the end of the tube-shaped member 61 at the opposite side to the side which faces the combustion chamber 5, a step part 61c is formed. In the present embodiment, a two-step step part 61c is formed. The steps of the step part 61c are formed so as to correspond to the shape of the projecting part 64a of the pipe-shaped member 64.

Referring to FIG. 15, the movement restricting device in the present embodiment is provided with a turning device which turns the pipe-shaped member 64. The pipe-shaped member 64 has a rack gear 64c which is arranged at its outer circumferential surface. The rack gear 64c is arranged so as to extend along the circumferential direction of the pipe-shaped member 64. The movement restricting device in the present embodiment includes a pinion gear 67 and a motor 66 for driving the pinion gear 67. The pinion gear 67 engages with the rack gear 64c. The motor 66 is controlled by the electronic control unit 31 (see FIG. 1). By the motor 66 being driven, the pinion gear 67 rotates. The rotating force of the pinion gear 67 is transmitted to the rack gear 64c, whereby, as shown by the arrow 202, the pipe-shaped member 64 turns in the circumferential direction.

FIG. 16 shows a schematic front view which explains the positional relationship between projecting part of the pipe-shaped member and the step part of the tube-shaped member in the present embodiment. By the pressure of the combustion chamber 5 reaching the control pressure, the tube-shaped member 61 moves toward the pipe-shaped member 64. The step part 61c of the tube-shaped member 61 abuts against the projecting part 64a of the pipe-shaped member 64 at any of the steps. By the projecting part 64a abutting against the step part 61c of the tube-shaped member 61, movement of the tube-shaped member 61 is restricted.

In the example which is shown in FIG. 16, the projecting part 64a of the pipe-shaped member 64 abuts against the deepest part of the step part 61c of the tube-shaped member 61. The tube-shaped member 61 becomes maximum in amount of movement. The motor 66 may be used to turn the pipe-shaped member 64 so as to make the projecting part 64a abut against the second deepest part of the step part 61c. The amount of movement of the tube-shaped member 61 can be reduced. Furthermore, by turning the pipe-shaped member 64, the projecting part 64a can be made to abut against the top surface of the tube-shaped member 61. The amount of movement of the tube-shaped member 61 can be minimized. The movement restricting device in the present embodiment can restrict the amount of movement of the tube-shaped member in stages.

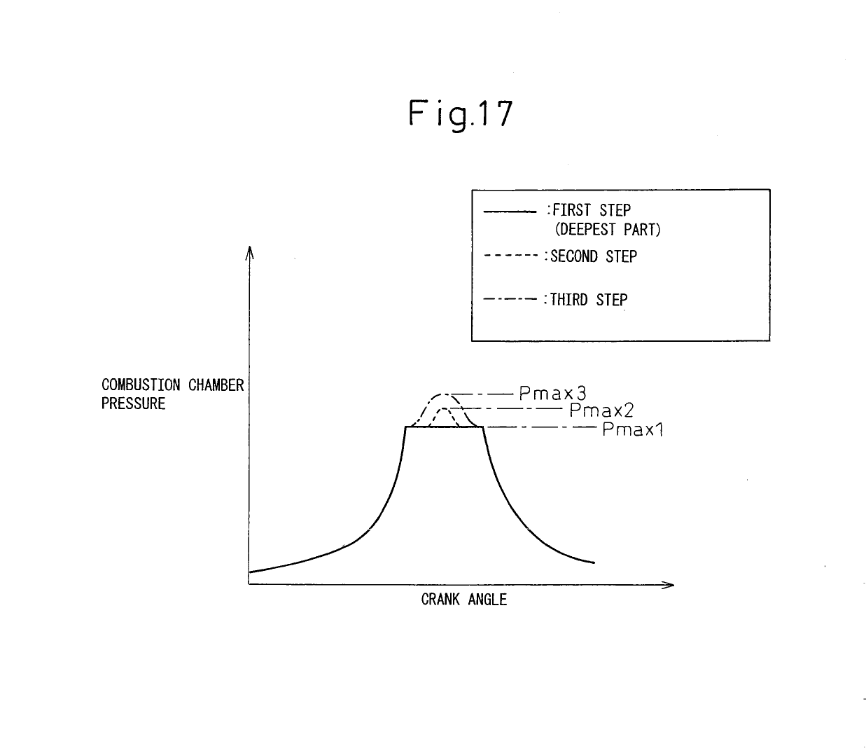

FIG. 17 shows a graph of the pressure of the combustion chamber of an internal combustion engine which is provided with the first combustion pressure control device in the present embodiment. The solid line graph is the graph of the time when the projecting part 64a of the pipe-shaped member 64 abuts against the deepest part (first step) of the step part 61c of the tube-shaped member 61. The broken line graph is a graph of the time when the projecting part 64a abuts against the second deepest part (second step) of the step part 61c. The one-dot chain line graph is a graph of the time when the projecting part 64a abuts against the top surface (third step) of the tube-shaped member 61. It is learned that the maximum pressures Pmax1, Pmax2, and Pmax3 of the combustion chamber gradually become larger.

In this way, in the first combustion pressure control device in the present embodiment, the pipe-shaped member 64 can be turned to change the position of the projecting part 64a and thereby change the amount of movement of the tube-shaped member 61. It is possible to change the maximum pressure which the combustion chamber reaches. When the amount of movement of the tube-shaped member 61 is large, the maximum pressure which the combustion chamber reaches can be kept small. Further, when the amount of movement of the tube-shaped member 61 is small, the maximum pressure which the combustion chamber reaches can be made larger.

The combustion pressure control device in the present embodiment is provided with an operating state detecting device which detects the operating state of the internal combustion engine. The combustion pressure control device in the present embodiment uses the detected operating state of the internal combustion engine as the basis to select the maximum pressure which the combustion chamber reaches. The selected maximum pressure of the combustion chamber can be used as the basis to change the amount of movement of the tube-shaped member.

Here, the operating state of the internal combustion engine for changing the maximum pressure of the combustion chamber will be explained with reference to the example of the engine speed. Referring to FIG. 1, the operating state detecting device includes a crank angle sensor 42 for detecting the engine speed.

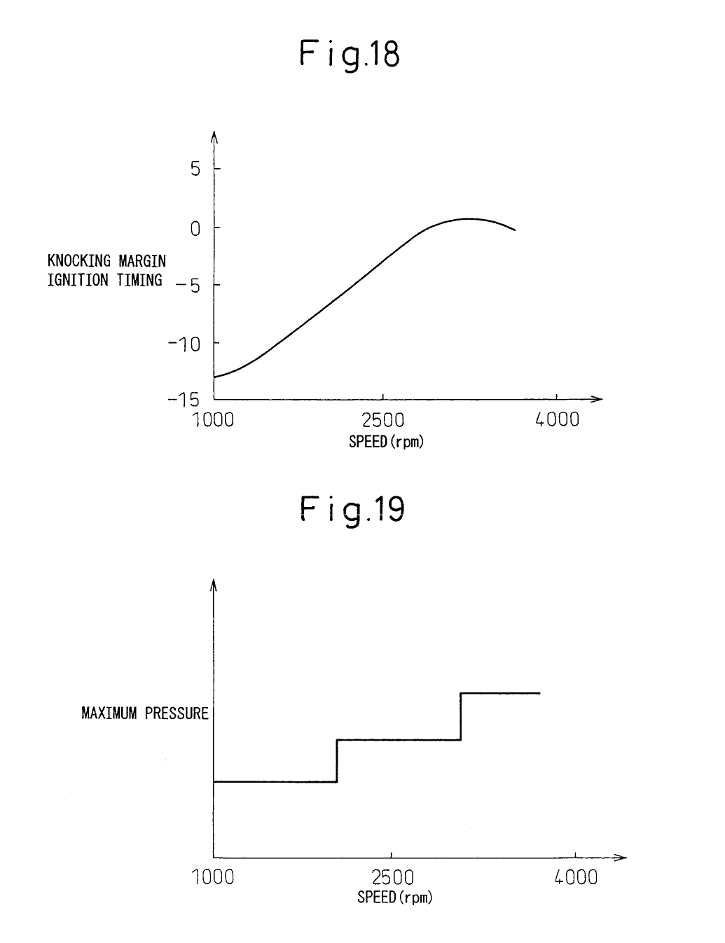

FIG. 18 shows a graph which explains the relationship between the speed and a knocking margin ignition timing of the internal combustion engine of the comparative example. The internal combustion engine of the comparative example is an internal combustion engine which does not have the combustion pressure control device in the present embodiment. The knocking margin ignition timing can be expressed by the following formula:

(Knocking margin ignition timing)=(Ignition timing at which knocking occurs)−(Ignition timing where output torque becomes maximum)

In the knocking margin ignition timing, the smaller the value, the more easily abnormal combustion occurs. Depending on the different speeds of internal combustion engines, the susceptibility to knocking differs. For this reason, in the combustion pressure control device of the present embodiment, the speed of the internal combustion engine is used as the basis to change the maximum pressure of the combustion chamber. In an internal combustion engine, generally, the higher the speed of the internal combustion engine, the shorter the combustion period, so the more difficult it is for abnormal combustion to occur.

FIG. 19 shows a graph of the maximum pressure of the combustion chamber with respect to the speed of the internal combustion engine in the combustion pressure control device of the present embodiment. In the present embodiment, the higher the speed of the internal combustion engine, the higher the maximum pressure of the combustion chamber is set. Referring to FIG. 1, in the present embodiment, the maximum pressure of the combustion chamber is stored as a function of the speed of the internal combustion engine in advance in the ROM 34 of the electronic control unit 31. The electronic control unit 31 uses a crank angle sensor 42 to detect the speed of the internal combustion engine and selects the maximum pressure of the combustion chamber in accordance with the speed. The electronic control unit 31 controls the motor 66 which turns the pipe-shaped member 64 so that the pipe-shaped member 64 becomes a position corresponding to the selected maximum pressure of the combustion chamber. In the example which is shown in FIG. 19, the higher the speed of the internal combustion engine, the more possible it is to control the amount of movement of the tube-shaped member to become smaller.

Further, the operating state detecting device in the present embodiment includes a fuel property detecting device which detects a property of the fuel which is fed to the combustion chamber. The detected property of the fuel is used as the basis to change the maximum pressure of the combustion chamber. For example, sometimes the fuel of an internal combustion engine contains alcohol. In the present embodiment, the explanation will be given with reference to the example of an internal combustion engine which detects the alcohol concentration as the property of the fuel. The properties at the time of operation of this internal combustion engine depend on the alcohol concentration.

FIG. 20 is a graph which explains the relationship between the concentration of alcohol which is contained in the fuel and the retardation correction amount in the internal combustion engine of the comparative example. The internal combustion engine of the comparative example retards the ignition timing when abnormal combustion occurs. The abscissa of FIG. 20 indicates the concentration of alcohol which is contained in the fuel, while the ordinate indicates the retardation correction amount when retarding the ignition timing so that abnormal combustion does not occur. The higher the concentration of alcohol which is contained in the fuel, the smaller the retardation correction amount. In this way, in the internal combustion engine, the higher the alcohol concentration, the greater the resistance to abnormal combustion. For this reason, in the combustion pressure control device in the present embodiment, the concentration of alcohol which is contained in the fuel is used as the basis to change the maximum pressure of the combustion chamber.

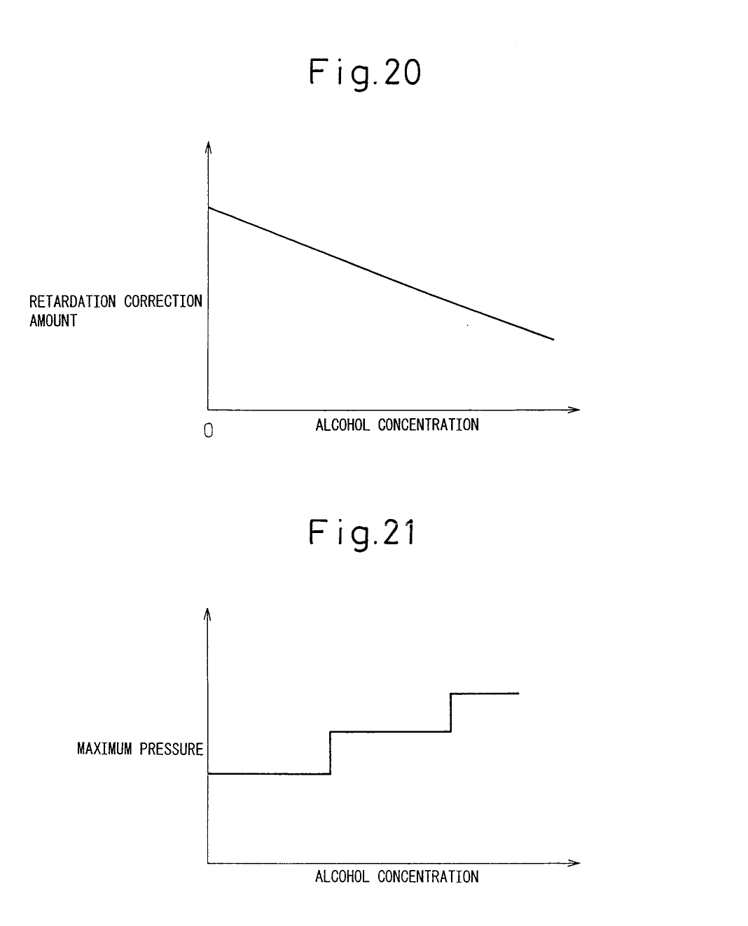

FIG. 21 shows a graph of the maximum pressure of the combustion chamber with respect to the concentration of alcohol which is contained in the fuel in the combustion pressure control device of the present embodiment. The higher the concentration of alcohol, the higher the maximum pressure of the combustion chamber is set. The fuel property detecting device in the present embodiment includes an alcohol concentration sensor which detects the concentration of alcohol which is contained in the fuel. Referring to FIG. 1, the internal combustion engine in the present embodiment arranges an alcohol concentration sensor as a fuel property sensor 45 in the fuel feed flow path. The maximum pressure of the combustion chamber demanded is stored as a function of the alcohol concentration in advance in the ROM 34 of the electronic control unit 31. The electronic control unit 31 detects the concentration of alcohol which is contained in the fuel and selects the maximum pressure of the combustion chamber in accordance with the concentration of alcohol. The electronic control unit 31 controls the motor 66 which turns the pipe-shaped member 64 so that the pipe-shaped member 64 becomes a position which corresponds to the selected maximum pressure of the combustion chamber. In the example which is shown in FIG. 21, control can be performed to reduce the amount of movement of the tube-shaped member the higher the concentration of alcohol which is contained in the fuel.

In the combustion pressure control device of the present embodiment, the maximum pressure of the combustion chamber is controlled in three stages, but the invention is not limited to this. Any number of stages of maximum pressure can be set. For example, the step part of the tube-shaped member can be provided with any number of steps. Alternatively, the tube-shaped member may include a slanted part where the height successively changes instead of the step part.

As the operating state of the internal combustion engine, in addition to the speed of the internal combustion engine and the properties of the fuel which are supplied, the intake temperature, cooling water temperature of the internal combustion engine, temperature of the combustion chamber right before ignition, etc. may be illustrated. The lower these temperatures, the higher the maximum pressure of the combustion chamber that can be set. For example, in an internal combustion engine, the lower the temperature of the air-fuel mixture at the time of ignition, the greater the resistance to abnormal combustion. Furthermore, when the compression ratio of the internal combustion engine is variable, the lower the compression ratio, the lower the temperature at the time of ignition. For this reason, the lower the compression ratio, the higher the maximum pressure of the combustion chamber can be made.

As the properties of the fuel, in addition to the alcohol concentration, the octane value of the gasoline or other indicators which show the knocking resistance may be illustrated. For example, it is possible to detect high octane value fuel or other fuel resistant to abnormal combustion being fed into the combustion chamber and raise the maximum pressure of the combustion chamber.

In this way, by changing the maximum pressure of the combustion chamber in accordance with the operating state of the internal combustion engine, the occurrence of abnormal combustion can be suppressed while the maximum pressure of the combustion chamber is made larger. It is therefore possible to suppress the occurrence of abnormal combustion while increasing the output torque or keeping down the amount of fuel consumption in accordance with the operating state.

Further, the movement restricting device in the present embodiment forms a step part at the tube-shaped member and forms a projecting part at the pipe-shaped member, but the invention is not limited to this. It is also possible to form the step part at the pipe-shaped member and form the projecting part at the tube-shaped member. Further, the movement restricting device in the present embodiment includes a pipe-shaped member which faces the end face of the tube-shaped member, but the invention is not limited to this. Any device which restricts the amount of movement of the tube-shaped member may be employed. For example, referring to FIG. 14, a rotatable movement restricting device is arranged at the inside of the cylinder head 4 and a projecting part is arranged toward the top side of the tube-shaped member from the inside of the cylinder head 4. By making the projecting part contact the step part, the amount of movement of the tube-shaped member can be restricted.

Referring to FIG. 14 and FIG. 15, the first combustion pressure control device in the present embodiment is provided with a blocking device which blocks at least part of the passage which communicates with the combustion chamber. The blocking device in the present embodiment is formed so that the smaller the flow sectional area of the passage which communicates with the combustion chamber, the more the circumferential direction flow or axial direction flow in the combustion chamber is promoted. The blocking device in the present embodiment includes a blocking member 64b which is attached to the pipe-shaped member 64. Further, the blocking device in the present embodiment includes a motor 66 which turns the pipe-shaped member 64.

The blocking member 64b in the present embodiment is formed so as to move integrally with the pipe-shaped member 64. The blocking member 64b is formed in a plate shape. The blocking member 64b in the present embodiment is formed into a cross-sectional arc shape. The blocking member 64b is formed so as to be able to block part of the opening part 61a which is formed at the tube-shaped member 61 by rotation of the pipe-shaped member 64.

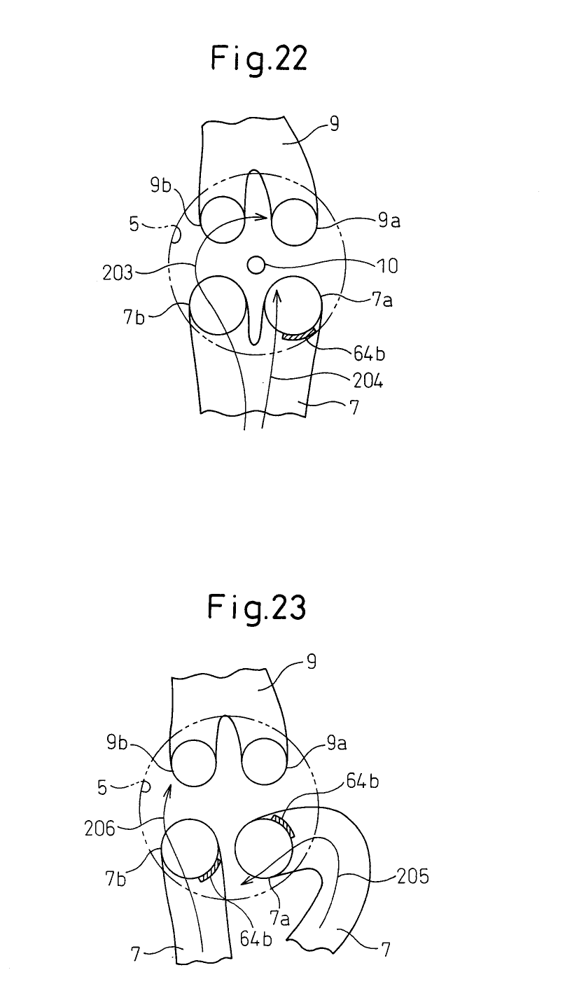

FIG. 22 shows a schematic cross-sectional view of an internal combustion engine which is provided with the first combustion pressure control device in the present embodiment. FIG. 22 is a schematic cross-sectional view of a combustion chamber, engine intake passage, and engine exhaust passage of the internal combustion engine. The combustion chamber 5 is fed a mixture of air and fuel through an engine intake passage constituted by the intake port 7. The exhaust gas which is produced due to combustion of the fuel in the combustion chamber 5 is discharged through an engine exhaust passage constituted by the exhaust port 9.

In the present embodiment, the cylinder head 4 is formed with entry parts 7a and 7b of the combustion chamber 5. Further, the cylinder head 4 is formed with exit parts 9a and 9b of the combustion chamber 5. The internal combustion engine in the present embodiment arranges two intake valves 6 and two exhaust valves 8 for one combustion chamber 5. The numbers of intake valves and exhaust valves which are arranged at one combustion chamber 5 are not limited to this. Any numbers may be employed.

In the example of the internal combustion engine which is shown in FIG. 22, among the entry part 7a and the entry part 7b of the combustion chamber 5, the blocking device of the combustion pressure control device is arranged corresponding to the entry part 7a. Referring to FIG. 15, by driving the motor 66, the pipe-shaped member 64 and the blocking member 64b rotate. By the blocking member 64b rotating, part of the opening part 61a of the tube-shaped member 61 is blocked. The flow sectional area of the engine intake passage becomes smaller.

Referring to FIG. 22, at the combustion chamber 5, the air-fuel mixture flows in from the entry part 7a as shown by the arrow 204. Further, at the combustion chamber 5, the air-fuel mixture flows in from the entry part 7b as shown by the arrow 203. By the blocking member 64b being arranged at the intake port 7 which communicates with the entry part 7a, the flow sectional area of the engine intake passage which communicates with the entry part 7a becomes smaller. The flow rate of the air-fuel mixture which flows in from the entry part 7a becomes smaller.

As opposed to this, the blocking member 64b is not arranged at the entry part 7b of the combustion chamber 5, so the flow rate of the air-fuel mixture which flows in from the entry part 7b becomes larger than the flow rate of the air-fuel mixture which flows in from the entry part 7a. For this reason, as shown by the arrow 203, a flow which circles along the circumferential direction of the combustion chamber 5 is promoted. That is, a swirl flow is promoted in the combustion chamber 5.

FIG. 23 shows a schematic cross-sectional view of another internal combustion engine which is provided with the first combustion pressure control device in the present embodiment. FIG. 23 is a schematic cross-sectional view of a combustion chamber, engine intake passage, and engine exhaust passage of another internal combustion engine. In another internal combustion engine, first combustion pressure control devices in the present embodiment are attached corresponding to both of the entry part 7a and the entry part 7b of the combustion chamber 5. In another internal combustion engine, to strengthen the swirl flow, the intake port 7 which is communicated with the entry part 7a is bent.

In another internal combustion engine, the blocking members 64b of the blocking devices which are arranged at the entry part 7a and the entry part 7b are used to block parts of the respective passages of the intake ports 7. The blocking member 64b which is arranged corresponding to the entry part 7a and the blocking member 64b which is arranged corresponding to the entry part 7b are arranged in regions near the center of the approximately circular shape when viewing the combustion chamber 5 from a plan view. These intake ports 7 open at regions close to the outer circumference of the combustion chamber 5. For this reason, the air-fuel mixture which flows through the entry part 7a into the combustion chamber 5, as shown by the arrow 205, promotes the flow in the circumferential direction of the combustion chamber 5. Further, the air-fuel mixture which flows through the entry part 7b into the combustion chamber 5, as shown by the arrow 206, promotes the flow in the circumferential direction of the combustion chamber 5. In this way, in another internal combustion engine as well, the flow in the circumferential direction can be promoted.

The blocking members 64b of the first combustion pressure control devices in the present embodiment are formed so as to block the entire opening parts 61a in the height direction, but the invention is not limited to this. They may also be formed so as to block parts of the opening parts 61a in the height direction. Further, the blocking members 64b may also be formed to block the entire opening parts 61a. Further, the blocking members of the blocking devices can be made any shapes which form a swirl flow in accordance with the angle or shape by which the engine intake passage is connected to the combustion chamber.

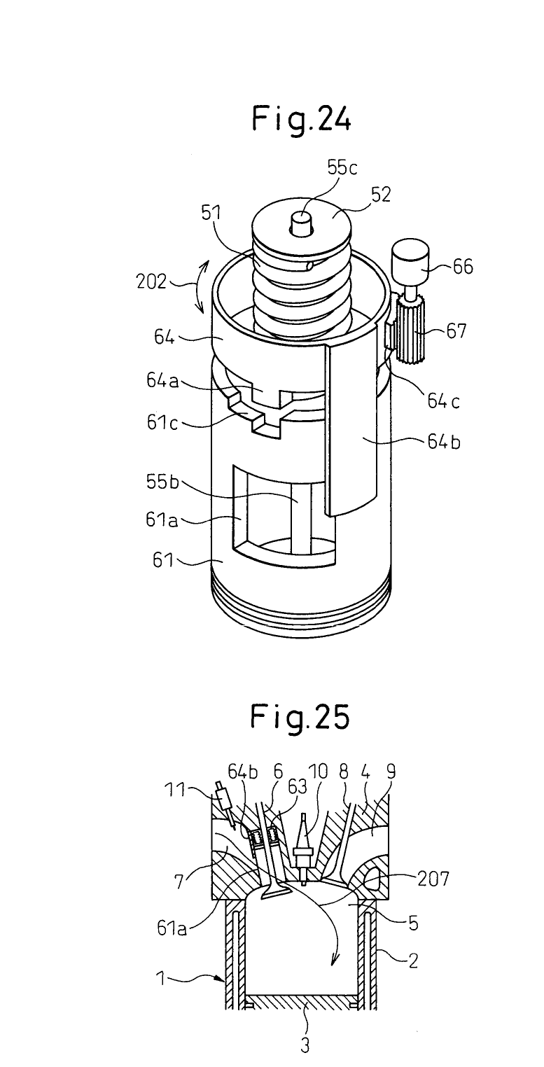

FIG. 24 is a schematic perspective view of the part of the tube-shaped member and pipe-shaped member of a second combustion pressure control device in the present embodiment. In the second combustion pressure control device, the pipe-shaped member 64 is provided with a blocking member 64b which is shorter in length in the height direction of the opening part 61a. The second combustion pressure control device promotes the flow in the axial direction in the combustion chamber 5. The blocking member 64b in the second combustion pressure control device is formed so as to block the top part in the opening part 61a of the tube-shaped member 61. In the present embodiment, the blocking member 64b blocks the approximately top half of the opening part 61a. At this time, the approximately bottom half of the opening part 61a is open.

FIG. 25 shows a schematic cross-sectional view of an internal combustion engine which is provided with the second combustion pressure control device in the present embodiment. FIG. 25 is a schematic cross-sectional view when a blocking device is used to block part of the engine intake passage. By using the blocking member 64b to block the top part of the opening part 61a of the tube-shaped member 61, the engine intake passage is restricted to the region at the bottom of the intake port 7. The air-fuel mixture which passes through the intake port 7 and flows into the combustion chamber 5, as shown by the arrow 207, becomes larger in speed component in the horizontal direction. As a result, the flow in the axial direction of the combustion chamber 5 can be promoted. That is, a tumble flow can be promoted in the combustion chamber 5.

The blocking member of the second combustion pressure control device in the present embodiment is formed so as to block part of the opening part 61a in the width direction, but the invention is not limited to this. The blocking member may so be formed so as to cover the entire width direction of the opening part 61a. Further, the blocking member of the blocking device may be made any shape which forms a tumble flow corresponding to the angle or shape by which the engine intake passage is connected to the combustion chamber.

Further, the blocking device in the present embodiment is formed by attaching a blocking member to a pipe-shaped member and rotating the blocking member so that the blocking member blocks the opening part of the tube-shaped member, but the invention is not limited to this. The blocking device need only be formed so as to block at least part of the passage which communicates with the combustion chamber and thereby promote a swirl flow, tumble flow, or other agitated flow in the combustion chamber.

In this regard, when the internal combustion engine is provided with an operating state detecting device, it is possible to form a swirl flow, tumble flow, or other agitated flow in accordance with the detected operating state.

An internal combustion engine sometimes is liable to misfire in a predetermined operating state. For example, in an internal combustion engine which is provided with an exhaust gas recirculation system or an internal combustion engine which burns fuel in a state increasing the air-fuel ratio at the time of combustion (for example, a lean burn engine), etc., misfire is sometimes liable to occur. In these internal combustion engine which is provided with an exhaust gas recirculation system and internal combustion engine which controls the air-fuel ratio to become large, the intake loss and exhaust loss can be reduced and the heat efficiency is improved. That is, the pumping loss becomes smaller and the heat efficiency is improved. In this regard, in such an internal combustion engine, the air-fuel ratio when the fuel is burning becomes larger, so the combustion speed becomes slower. For this reason, misfire easily occurs in the combustion chamber.

In an internal combustion engine in which misfire is liable to occur, it is possible to form a swirl flow or tumble flow or other agitated flow inside of the combustion chamber so as to increase the combustion speed and suppress misfire. On the other hand, if forming a swirl flow, tumble flow, etc. in the combustion chamber, the combustion speed becomes larger, so the heat efficiency becomes lower. If the combustion speed is large, the highest temperature of the combustion gas when burned becomes higher. For this reason, the amount of heat which is discharged from the combustion chamber to the outside becomes larger and the heat efficiency becomes lower.

Referring to FIG. 15 and FIG. 24, the first combustion pressure control device and the second combustion pressure control device in the present embodiment are provided with a movement restricting device and blocking device. The combustion pressure control device in the present embodiment is formed so that the smaller the flow sectional area of the passage which communicates with the combustion chamber due to the blocking device, the smaller the amount of movement the tube-shaped member is restricted to. That is, it is formed so that the stronger the agitated flow in the combustion chamber is promoted, the higher the highest pressure of the combustion chamber becomes. For this reason, the agitated flow can be promoted and misfire suppressed while the heat efficiency is raised.

Referring to FIG. 1, the internal combustion engine in the present embodiment is provided with an exhaust gas recirculation system. The exhaust gas recirculation system includes an EGR gas supply line 26 and EGR control valve 27. The recirculation rate of the exhaust gas can be adjusted by changing the opening degree of the EGR control valve 27. In the present embodiment, the operating state detecting device detects the recirculation rate of the exhaust gas. The recirculation rate of the exhaust gas can be estimated based on the output value of the air flow meter 16, the opening degree of the EGR control valve, etc.

The internal combustion engine in the present embodiment can use the blocking device to reduce the flow sectional area of the engine intake passage to promote an agitated flow in the combustion chamber when increasing the recirculation rate of the exhaust gas. By promoting an agitated flow, misfires can be suppressed. Furthermore, the movement restricting device can be used to reduce the amount of movement of the tube-shaped member so as to increase the maximum pressure which the combustion chamber reaches. By increasing the maximum pressure which the combustion chamber reaches, the heat efficiency can be improved.

Further, the internal combustion engine in the present embodiment can perform control so that the air-fuel ratio at the time of combustion becomes large. In the present embodiment, the operating state detecting device detects the air-fuel ratio at the time of combustion. The air-fuel ratio at the time of combustion can be estimated based on the amount of injection of fuel from the fuel injector 11, the output value of the air flow meter 16, etc. The internal combustion engine in the present embodiment can use the blocking device to reduce the flow sectional area of the engine intake passage and promote an agitated flow in the combustion chamber when increasing the air-fuel ratio at the time of combustion. By promoting an agitated flow, misfire can be prevented. Furthermore, the movement restricting device can be used to reduce the amount of movement of the tube-shaped member and increase the maximum pressure which the combustion chamber reaches. By increasing the maximum pressure which the combustion chamber reaches, the heat efficiency can be improved.

In this way, the combustion pressure control device in the present embodiment can promote an agitated flow which is formed in the combustion chamber and raise the maximum pressure which is reached in the combustion chamber.

The combustion pressure control device in the present embodiment is provided with both the movement restricting device which restricts the amount of movement of the tube-shaped member and the blocking device which blocks at least part of the passage which communicates with the combustion chamber, but the invention is not limited to this. The combustion pressure control device may also be provided with just one. For example, a combustion pressure control device which does not include a blocking device, but includes a movement restricting device may also be arranged in the region where the exhaust valve is arranged.

The rest of the configuration, actions, and effects are similar to those of Embodiment 1, so the explanations will not be repeated here.

### Embodiment 3

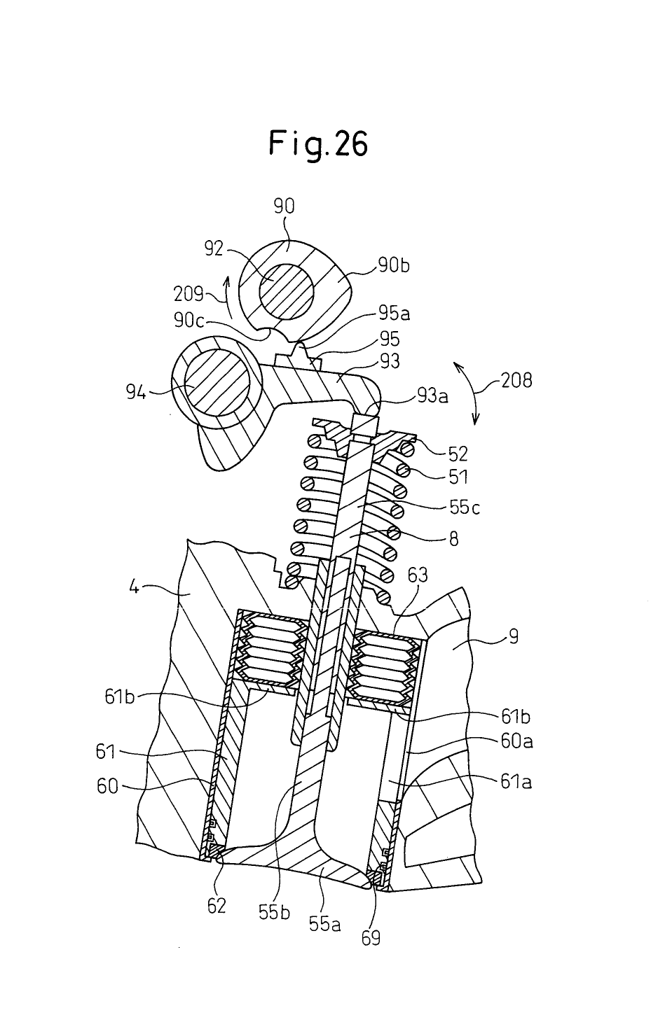

Referring to FIG. 26 to FIG. 35, an internal combustion engine in Embodiment 3 will be explained. The internal combustion engine in the present embodiment is provided with a combustion pressure control device. In the present embodiment, the explanation will be given with reference to the example of a combustion pressure control device which is arranged in a region where the exhaust valve is arranged.

FIG. 26 is a schematic cross-sectional view of the first combustion pressure control device in the present embodiment. At the part where the exhaust port 9 is connected to the combustion chamber 5, a frame member 60, tube-shaped member 61, and fluid spring 63 are arranged in the same way as the first combustion pressure control device in Embodiment 1 (see FIG. 2). The first combustion pressure control device of the present embodiment does not have a coil spring arranged between the first stem 55b and the second stem 55c of the exhaust valve 8. The shaft-shaped part of the exhaust valve 8 is comprised of the first stem 55b and the second stem 55c formed integrally.

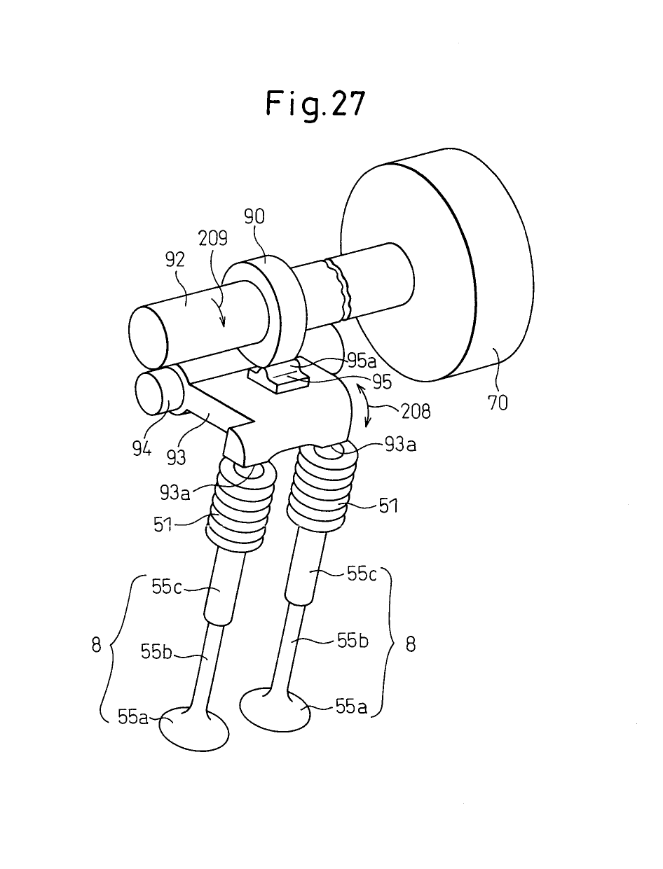

FIG. 27 shows a schematic perspective view of the part of the cam and the rocker arm which drive the exhaust valve. Referring to FIG. 26 and FIG. 27, the combustion pressure control device in the present embodiment is provided with a cam for closing or opening the on-off valve. The combustion pressure control device in the present embodiment is provided with an exhaust cam 90 which drives the exhaust valve 8.

The exhaust cam 90 is supported by the cam shaft 92. As shown by the arrow 209, by the cam shaft 92 rotating, the exhaust cam 90 rotates. The combustion pressure control device in the present embodiment is provided with a rocker arm 93 serving as a transmission member which transmits the drive force of the exhaust cam 90. The rocker arm 93 is supported by a rocker shaft 94. The rocker arm 93, as shown by the arrow 208, is formed so as to swing using the rocker shaft 94 as the center of rocking. The rocker arm 93 has a pushing part 93a which pushes the exhaust valve 8. The pushing part 93a is formed so as to push the end part of the second stem 55c of the exhaust valve 8.

The rocker arm 93 in the present embodiment has an abutting part 95 which abuts against the exhaust cam 90. The abutting part 95 has a projecting part 95a which sticks out toward the exhaust cam 90. The projecting part 95a in the present embodiment is formed so as to extend in the width direction of the exhaust cam 90.

The combustion pressure control device in the present embodiment is provided with a variable valve mechanism which changes the phase of the exhaust cam with respect to the crank angle. That is, it is provided with a variable valve mechanism which changes the phase of the exhaust cam with respect to the position of the piston 3 in the cylinder. In the present embodiment, as the variable valve mechanism, a variable valve timing device 70 is provided. The variable valve timing device 70 is attached to an end part of the cam shaft 92. The variable valve timing device 70 is connected to an output port 36 of the electronic control unit 31. The variable valve timing device 70 is controlled by the electronic control unit 31 (see FIG. 1).

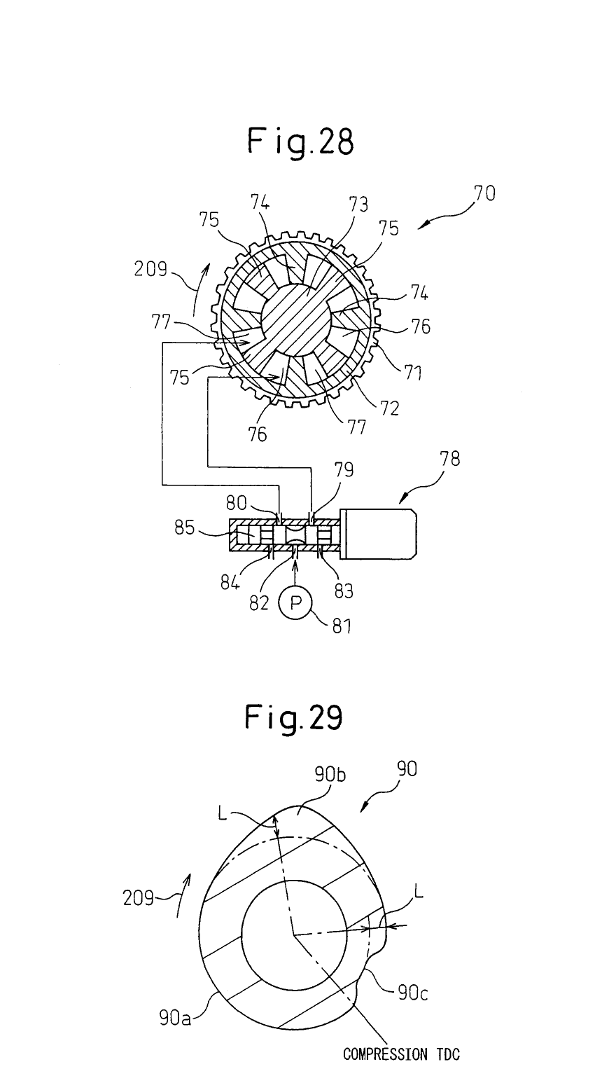

FIG. 28 shows a schematic view of a variable valve timing device in the present embodiment. The variable valve timing device 70 in the present embodiment is provided with a timing pulley 71 which rotates in the direction of the arrow 209 by a timing belt which is engaged with a crankshaft of the engine body and a cylindrical housing 72 which rotates together with the timing pulley 71. The variable valve timing device 70 is provided with a rotary shaft 73 which rotates together with the cam shaft 92 and can rotate relative to the cylindrical housing 72, a plurality of partition walls 74 which extend from an inner circumferential surface of the cylindrical housing 72 to an outer circumferential surface of the rotary shaft 73, and a vane 75 which extends between each two partition walls 74 from the outer circumferential surface of the rotary shaft 73 to the inner circumferential surface of the cylindrical housing 72. At the two sides of each vane 75, an advancement-use hydraulic chamber 76 and a retardation-use hydraulic chamber 77 are formed.

The variable valve timing device 70 includes a feeding device which feeds working oil to the hydraulic chambers 76 and 77. The feeding device includes a working oil feed control valve 78. The working oil feed control valve 78 includes hydraulic ports 79 and 80 which are respectively connected to the hydraulic chambers 76 and 77, a feed port 82 of working oil which is discharged from the hydraulic pump 81, a pair of drain ports 83 and 84, and a spool valve 85 which communicates and blocks the ports 79, 80, 82, 83, and 84.

When making the phase of the exhaust cam 90 which is fastened to the cam shaft 92 advance, in FIG. 28, the spool valve 85 is moved to the right. Working oil which is fed from the feed port 82 is fed through the hydraulic port 79 to the advancement-use hydraulic chamber 76 and working oil inside of the retardation-use hydraulic chamber 77 is discharged from the drain port 84. At this time, the rotary shaft 73 is made to rotate relative to the cylindrical housing 72 in the direction of the arrow 209.

As opposed to this, when retarding the phase of the exhaust cam 90 which is fastened to the cam shaft 92, in FIG. 28, the spool valve 85 is moved to the left. The working oil which is fed from the feed port 82 is fed through the hydraulic port 80 to the retardation-use hydraulic chamber 77 and the working oil inside the advancement-use hydraulic chamber 76 is discharged from the drain port 83. At this time, the rotary shaft 73 is rotated relative to the cylindrical housing 72 in the direction opposite to the arrow 209.

When the rotary shaft 73 rotates relative to the cylindrical housing 72, the spool valve 85 is returned to the neutral position whereby the rotating action of the rotary shaft 73 stops. The rotary shaft 73 is held at the position at that time. Therefore, the variable valve timing device 70 can be used to make the phase of the exhaust cam 90 which is fastened to the cam shaft 92 advance by exactly the desired amount. Alternatively, the phase of the exhaust cam 90 can be retarded by exactly the desired amount.

In this way, by driving the variable valve timing device, the phase of the exhaust cam 90 relative to the crank angle can be made to change within a predetermined range of angle. Note that, the variable valve mechanism is not limited to the above variable valve timing device. Any device which can adjust the phase of the cam can be employed.

FIG. 29 shows an enlarged schematic cross-sectional view of an exhaust cam in the present embodiment. The exhaust cam 90 has a base circle part 90a which has an approximately circular shape in a cross-sectional view and cam nose part 90b which bulges out from the base circle part 90a to the outside. If referring to the amount of bulge from the base circle part 90a in the radial direction as “the amount of cam lift L”, at the cam nose part 90b, the amount of cam lift L becomes a positive value. Referring to FIG. 26, the cam nose part 90b pushes against the projecting part 95a of the abutting part 95, whereby the rocker arm 93 rocks. By the pushing part 93a of the rocker arm 93 pushing the exhaust valve 8, the exhaust valve 8 opens.

Referring to FIG. 29, the exhaust cam 90 in the present embodiment has a recessed part 90c which is recessed from part of the outer circumferential surface. In the range where the recessed part 90c is formed, the amount of cam lift L becomes a negative value. The recessed part 90c in the present embodiment is formed by a depth and phase enabling the exhaust valve 8 to freely move in a direction away from the combustion chamber 5 during the time period when the phase of the exhaust cam 90 is set to the retarded side and the pressure of the combustion chamber 5 reaches the control pressure.

Referring to FIG. 26, if the phase of the exhaust cam 90 is set the retarded side and the pressure of the combustion chamber 5 reaches the control pressure, the fluid spring 63 contracts. The exhaust valve 8 moves in a direction away from the combustion chamber 5. The front end of the exhaust valve 8 lifts up the pushing part 93a of the rocker arm 93. At this time, the projecting part 95a of the abutting part 95 is arranged at the inside of the recessed part 90c of the exhaust cam 90. A clearance is formed between the projecting part 95a and the bottom surface of the recessed part 90c. In this way, the recessed part 90c is formed so that the on-off valve can move in accordance with the amount of contraction of the fluid spring 63 in the time period when the fluid spring 63 is contracting.

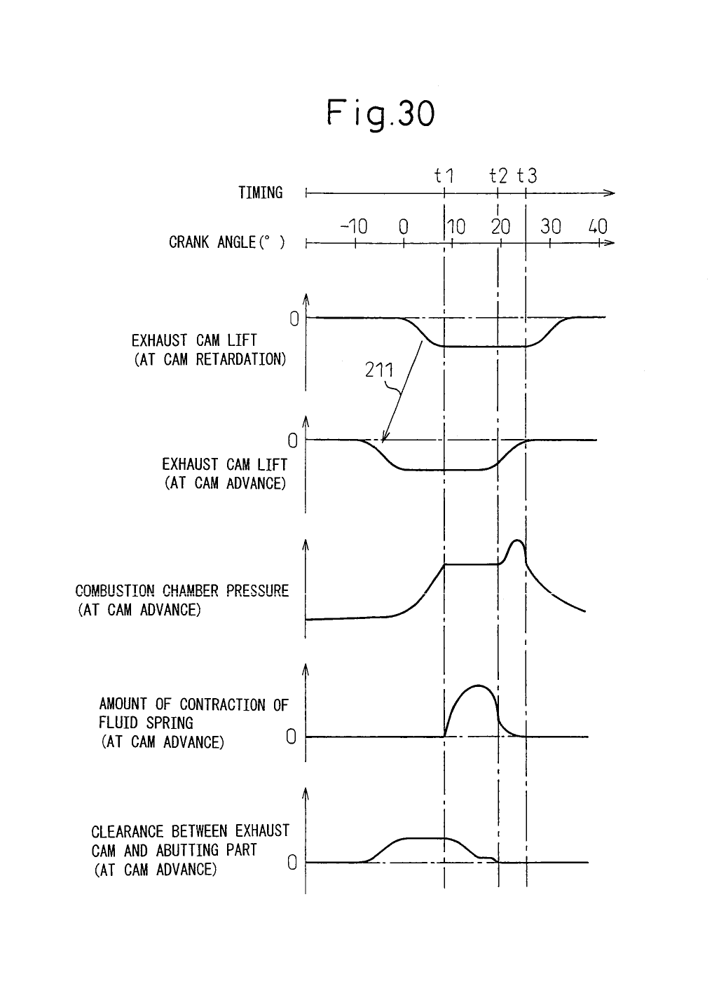

FIG. 30 shows a time chart of the combustion pressure control device in the present embodiment. The amount of cam lift of the exhaust cam will be explained for the case of setting the exhaust cam at a retarded side phase and the case of setting the exhaust cam at an advanced side phase. In the example which is shown in FIG. 30, in the time period from the timing t1 to the timing t3, the pressure of the combustion chamber is the control pressure or more and the fluid spring 63 contracts.

When setting the phase of the exhaust cam at the retarded side, in the time period after ignition until the pressure rises, the amount of cam lift is substantially zero. Along with the rise of the pressure of the combustion chamber, the amount of cam lift decreases. In the example which is shown in FIG. 30, the amount of cam lift L of the exhaust cam becomes the minimum until the timing t1. In the time period from the timing t1 to the timing t3, the minimum amount of cam lift is maintained. When setting the phase of the exhaust cam at the retarded side, a clearance is formed between the projecting part 95a of the abutting part 95 and the recessed part 90c until the pressure of the combustion chamber reaches the control pressure. The constraint on the exhaust valve 8 is released. The exhaust valve 8 is raised corresponding to the amount by which the fluid spring 63 contracts. For this reason, the pressure of the combustion chamber in the case of setting the phase of the exhaust cam at the retarded side is held substantially constant in the time period when the fluid spring 63 is contracting as shown in Embodiment 1 (for example, see FIG. 5).

The combustion pressure control device in the present embodiment is provided with an operating state detecting device. The operating state detecting device detects the operating state and, in a predetermined operating state, performs control so as to make the maximum pressure of the combustion chamber rise. In the combustion pressure control device in the present embodiment, when making the maximum pressure of the combustion chamber rise, the variable valve timing device 70 is used to make the phase of the exhaust cam 90 advance.

By using the variable valve timing device 70 to make the phase of the exhaust cam 90 advance, as shown by the arrow 211, the timing where the amount of lift of the exhaust cam becomes negative becomes earlier. The phase of the recessed part 90c of the exhaust cam 90 advances. For this reason, in the latter half of the time period when the pressure of the combustion chamber 5 reaches the control pressure, the projecting part 95a of the abutting part 95 can be made to contact the wall surface of the recessed part 90c of the exhaust cam 90. The wall surface of the recessed part 90c of the exhaust cam 90 is used to push the abutting part 95. For this reason, movement of the exhaust valve 8 in a direction away from the combustion chamber 5 is restricted. The exhaust valve 8 is pushed through the rocker arm 93. The exhaust valve 8 moves toward the combustion chamber 5. The volume of the combustion chamber 5 becomes smaller and the pressure of the combustion chamber 5 rises.

In the example of operational control which is shown in FIG. 30, at the timing t2, the projecting part 95a of the abutting part 95 contacts the wall surface of the recessed part 90c. At the timing t2, the clearance between the projecting part 95a and the recessed part 90c of the exhaust cam 90 becomes zero. In the time period from the timing t2 to the timing t3, the exhaust valve 8 is moving toward the combustion chamber 5. The amount of contraction of the fluid spring 62 accompanying this movement is rapidly decreased from the case of setting the phase of the exhaust cam 90 at the retarded side and approaches zero. In the time period from the timing t2 to the timing t3, the pressure of the combustion chamber 5 rises.

In this way, in the combustion pressure control device of the present embodiment, it is possible to use the variable valve timing device to change the phase of the cam and thereby restrict the amount of movement of the exhaust valve during the time period when the fluid spring is contracting. In the combustion pressure control device of the present embodiment as well, in the same way as the combustion pressure control device in Embodiment 2, the maximum pressure of the combustion chamber can be adjusted in accordance with the operating state which is detected by the operating state detecting device.

In the example of operational control which is shown in FIG. 30, in the time period when the pressure of the combustion chamber reaches the control pressure, the amount of movement of the exhaust valve is restricted in the time period when the amount of contraction of the fluid spring is decreasing. By advancing the phase of the exhaust cam, the maximum pressure of the combustion chamber is made to rise, but the invention is not limited to this. It is also possible to retard the phase of the exhaust cam to thereby bring the abutting part of the rocker arm into contact with the wall surface of the recessed part of the exhaust cam so as to make the maximum pressure of the combustion chamber rise. That is, the amount of movement of the exhaust valve may also be restricted in the time period during which the amount of contraction of the fluid spring increases. However, by restricting the amount of movement of the exhaust valve in the time period when the amount of contraction of the fluid spring is decreasing, the friction between the recessed part of the exhaust cam and the abutting part of the rocker arm can be reduced. Alternatively, the torque for turning the exhaust cam can be reduced.

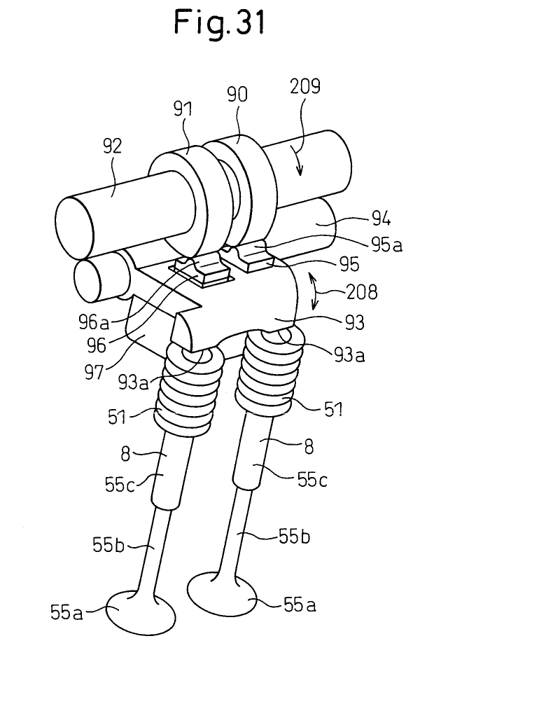

FIG. 31 shows a schematic perspective view of the part of the exhaust cam and the rocker arm in the second combustion pressure control device in the present embodiment. The second combustion pressure control device of the present embodiment is provided with the first exhaust cam 90 and the second exhaust cam 91 for driving the exhaust valve 8 and is formed so that two exhaust cams can be switched between. The rocker arm 93 has an abutting part 95 which abuts against the first exhaust cam 90 and an abutting part 96 which abuts against the second exhaust cam 91. The second combustion pressure control device in the present embodiment is not provided with the variable valve timing device, but the invention is not limited to this. The variable valve timing device may also be provided.

The first exhaust cam 90 is similar to the exhaust cam 90 of the first combustion pressure control device in the present embodiment (see FIG. 29). The first exhaust cam 90 is formed with a recessed part 90c. The recessed part 90c is formed so as not to constrain the movement of the exhaust valve 8 in the time period when the pressure of the combustion chamber 5 reaches the control pressure.

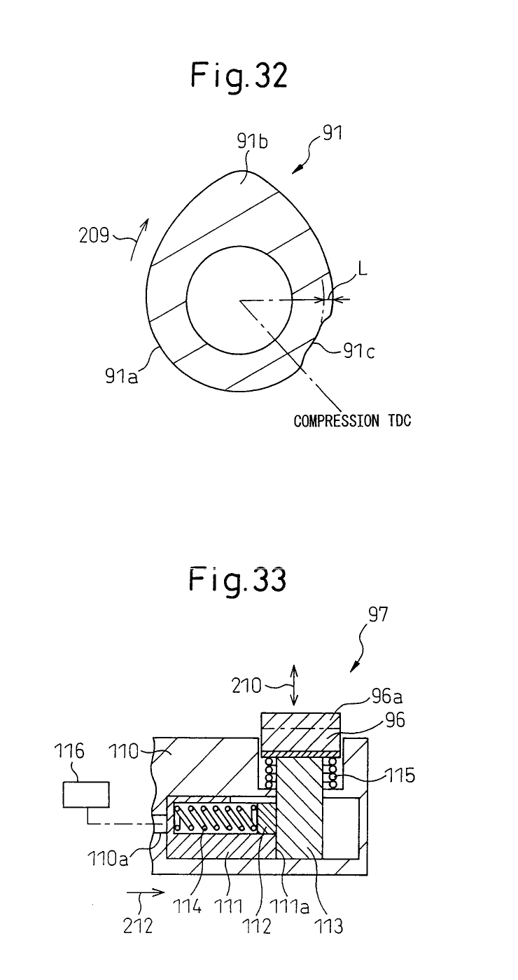

FIG. 32 shows a schematic cross-sectional view of a second exhaust cam in the present embodiment. The second exhaust cam 91 in the present embodiment has a base circle part 91a which has an approximately circular shape in a cross-sectional view, cam nose part 91b, and recessed part 91c. The recessed part 91c of the second exhaust cam 91 is formed shallower than the recessed part 90c of the first exhaust cam 90. The magnitude (absolute value) of the amount of negative lift L at the bottom of the recessed part 91c of the second exhaust cam 91 is smaller than the magnitude (absolute value) of the amount of lift L of the bottom of the recessed part 90c of the first exhaust cam 90. The recessed part 91c is formed in the region or phase which drives the exhaust valve during the time period when the pressure of the combustion chamber reaches the control pressure. Furthermore, the recessed part 91c is formed shallow so as to constrain movement of the exhaust valve 8 during the time period when the pressure of the combustion chamber reaches the control pressure.

Referring to FIG. 31, the combustion pressure control device of the present embodiment is provided with a switching device 97 which switches between the first exhaust cam 90 and the second exhaust cam 91 as the cam for operating the exhaust valve 8. The cam switching device 97 in the present embodiment is formed to be able to transmit the drive force of the second exhaust cam 91 to the rocker arm 93 and disengage it. When the drive force of the second exhaust cam 91 is transmitted to the rocker arm 93, the transmission of the drive force of the first exhaust cam 90 is disengaged.

FIG. 33 shows a first schematic cross-sectional view of a cam switching device in the present embodiment. FIG. 33 is a schematic cross-sectional view when the transmission of drive power of the second exhaust cam 91 is disengaged. The cam switching device in the present embodiment is provided with a housing 110. Inside of the housing 110, a stopper member 111 is arranged. The stopper member 111 is formed into a cross-sectional U-shape. The stopper member 111 is formed to be able to move at the inside of the housing 110.

Inside of the stopper member 111, a spring 114 is arranged. At the front end of the spring 114, a pushing member 112 is arranged. The spring 114 biases the pushing member 112 in the pushing direction. The stopper member 111 is pushed to the opposite side from the side facing the supporting member 113.

The switching device in the present embodiment includes the supporting member 113 which is fastened to the abutting part 96. The supporting member 113 is supported by the housing 110. The supporting member 113 is formed to be able to move in the axial direction with respect to the housing 110. The end face 111a of the stopper member 111 abuts against the supporting member 113. Further, the end face of the pushing member 112 also abuts against the supporting member 113. The abutting part 96 is biased by the spring 115 to the side where the abutting part 96 faces the exhaust cam 91. The abutting part 96 is biased in a direction where it jumps out from the housing 110. The abutting part 96 and the supporting member 113, as shown by the arrow 210, freely move in the direction in which the supporting member 113 extends.

Referring to FIG. 31 and FIG. 33, by the second exhaust cam 91 pushing against the abutting part 96, the spring 115 contracts and the abutting part 96 is pushed down. FIG. 33 shows the state where the abutting part 96 is pushed down. The drive force of the second exhaust cam 91 is absorbed by the movement of the abutting part 96 and the supporting member 113. The link between the second exhaust cam 91 and the rocker arm 93 is disengaged. In this case, the rocker arm 93 is driven by the first exhaust cam 90.

The housing 110 of the cam switching device 97 is formed with an oil path 110a. The oil path 110a is formed so as to be able to feed working oil to the space in which the stopper member 111 is arranged. The oil path 110a is, for example, connected through the oil path which is formed at the inside of the rocker shaft 94 to the working oil feeding device 116. The inside of the housing 110 is fed with working oil for pushing the stopper member 111 in the direction which is shown by the arrow 212.

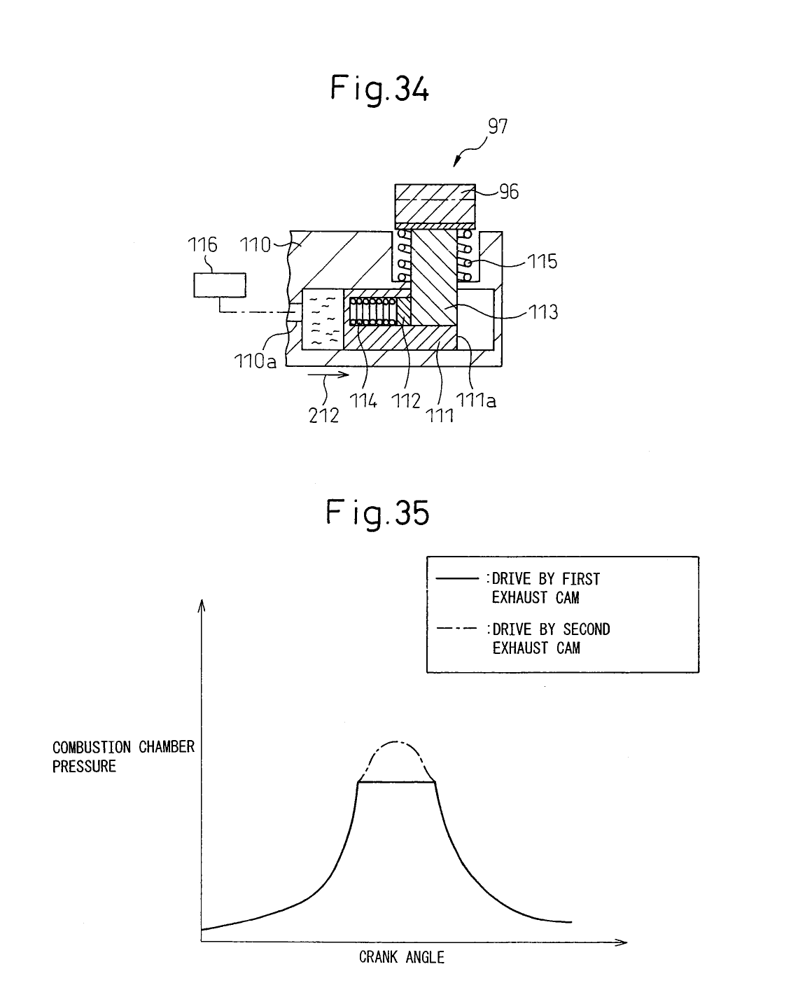

FIG. 34 shows a second schematic cross-sectional view of a cam switching device in the present embodiment. FIG. 34 is a schematic cross-sectional view when the drive force of the second exhaust cam 91 is being transmitted. The working oil feeding device 116 is used to feed the pressurized oil which has passed through the oil line 110a to the inside of the housing 110. Due to a pushing force of the working oil larger than the biasing force of the spring 114, the stopper member 111 moves in the direction which is shown by the arrow 212. When the abutting part 96 rises, the stopper member 111 moves, whereby part of the stopper member 111 is arranged below the supporting member 113. For this reason, the abutting part 96 and the supporting member 113 are restricted from moving in a direction away from the second exhaust cam 91.

In this case, referring to FIG. 31, the drive force by the second exhaust cam 91 is transmitted to the rocker arm 93. The first exhaust cam 90 and the second exhaust cam 91 have substantially the same shapes of the base circle parts 90a and 91a and cam nose parts 90b and 91b. In this regard, the recessed part 91c of the second exhaust cam 91 is formed so as to restrict the amount of movement of the exhaust valve 8. The projecting part 96a of the abutting part 96 contacts the recessed part 91c of the second exhaust cam 91. In the time period during which the pressure of the combustion chamber reaches the control pressure, movement of the exhaust valve 8 toward the outside of the combustion chamber can be restricted. The exhaust valve 8 is pushed by the second exhaust cam 91. The amount of contraction of the fluid spring and the amount of movement of the tube-shaped member can be restricted. As a result, the maximum pressure which the combustion chamber 5 reaches can be raised. On the other hand, the projecting part 95a of the abutting part 95 is separated from the recessed part 90c of the first exhaust cam 90 in this state. The transmission of the drive force of the first exhaust cam 90 is disengaged.

FIG. 35 is a graph of the pressure of the combustion chamber of the second combustion pressure control device in the present embodiment. It is learned that compared to when using the first exhaust cam 90 to drive the exhaust valve, using the second exhaust cam 91 to drive the exhaust valve increases the maximum pressure which the combustion chamber reaches.

In the second combustion pressure control device of the present embodiment, by switching the exhaust cam, it is possible to adjust the maximum pressure which the combustion chamber reaches. For example, the operating state detecting device can be used to detect the operating state of the internal combustion engine and the maximum pressure of the combustion chamber can be selected in accordance with the operating state.

The cam switching device of the second combustion pressure control device in the present embodiment is formed so as to transmit or disengage the drive force of the second exhaust cam, but the invention is not limited to this. The cam switching device can be made any device which can switch among a plurality of cams. Further, in the present embodiment, two cams are arranged, but the invention is not limited to this. Three or more cams may also be arranged.

In the first combustion pressure control device and the second combustion pressure control device of the present embodiment, the drive force of the exhaust cam is transmitted through the rocker arm to the exhaust valve, but the invention is not limited to this. It is also possible to configure them so that the drive force of the exhaust valve is directly transmitted to the exhaust valve without going through the rocker arm.

Further, in the combustion pressure control device of the present embodiment, the explanation was given with reference to an example in which an on-off valve constituted by the exhaust valve and a cam constituted by the exhaust cam are provided, but the invention is not limited to this. It is also possible to provide an on-off valve constituted by an intake valve and a cam constituted by an intake cam. That is, the combustion pressure control device in the present embodiment may also be arranged in a region in which the intake valve is provided.

The rest of the configuration, actions, and effects are similar to those of Embodiment 1 or 2, so the explanation will not be repeated.

### Embodiment 4

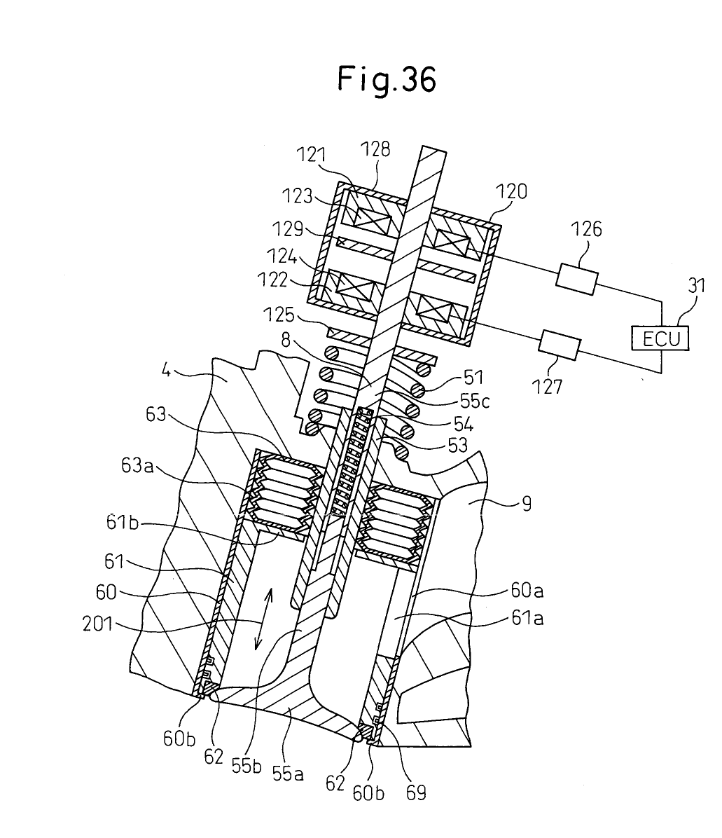

Referring to FIG. 36 to FIG. 40, the internal combustion engine in Embodiment 4 will be explained. The internal combustion engine in the present embodiment is provided with a combustion pressure control device. In the present embodiment, among the intake valve and the exhaust valve, the explanation will be given with reference to the example of a combustion pressure control device which is attached to a region in which the exhaust valve is provided.

FIG. 36 is a schematic cross-sectional view of the combustion pressure control device in the present embodiment. The part where the exhaust port 9 is connected to the combustion chamber 5 being provided with the frame member 60, tube-shaped member 61, and fluid spring 63 is similar to the structure in the first combustion pressure control device in Embodiment 1 (see FIG. 2). The combustion pressure control device in the present embodiment differs from Embodiment 1 in the drive device which operates the on-off valve constituted by the exhaust valve 8. The combustion pressure control device in the present embodiment is provided with an electromagnetic drive device 120 for driving the exhaust valve 8. The electromagnetic drive device 120 includes an electromagnet. The magnetic force of the electromagnet can be used to open the exhaust valve 8.

The electromagnetic drive device 120 in the present embodiment includes a housing 128. The housing 128 in the present embodiment is fastened to the cylinder head 4. At the inside of the housing 128, the upper core 121 and the lower core 122 are arranged. The upper core 121 and the lower core 122 are formed by a magnetic substance. The upper core 121 and the lower core 122 are fastened to the housing 128. At the inside of the upper core 121, the upper coil 123 is arranged. Furthermore, at the inside of the lower core 122, the lower coil 124 is arranged. The upper coil 123 is connected to a power feeding device 126 which feeds power for magnetization. The lower coil 124 is connected to a power feeding device 127 which feeds power for magnetization. These power feeding devices 126 and 127 are controlled by the electronic control unit 31.

The second stem 55c of the exhaust valve 8 passes through the upper core 121 and the lower core 122. The second stem 55c is formed to be able to move inside of the upper core 121 and the lower core 122. The spring retainer 125 for fastening the valve spring 51 is fastened to the second stem 55c of the exhaust valve 8.

The electromagnetic drive device 120 includes a mover 129 which is fastened to the second stem 55c. The mover 129 is arranged between the upper core 121 and the lower core 122. The mover 129 is formed by a magnetic substance. The exhaust valve 8 moves in the direction which is shown by the arrow 201. In the state where the upper coil 123 and the lower coil 124 are not electrified, the exhaust valve 8 closes due to the biasing force of the valve spring 51. When opening the exhaust valve 8, the lower coil 124 is electrified and the lower core 122 is magnetized. The mover 129 is pulled to the lower core 122. The second stem 55c moves toward the combustion chamber side, whereby the exhaust valve 8 can be opened. Note that, the electromagnetic drive device is not limited to the above. Any electromagnetic drive device which enables an on-off valve to be operated by magnetic force may be employed.

The combustion pressure control device in the present embodiment suppresses the rise of the pressure of the combustion chamber 5 by the fluid spring 63 contracting and the tube-shaped member 61 and tapered plug part 55a moving when the pressure of the combustion chamber reaches the control pressure. Furthermore, the combustion pressure control device in the present embodiment can adjust the pressure of the combustion chamber 5 by driving the electromagnetic drive device 120 in the time period when the pressure of the combustion chamber 5 reaches the control pressure.

The combustion pressure control device in the above embodiments is formed so that the coil spring 54 contracts when the pressure of the combustion chamber reaches the control pressure and the tapered plug part 55a moves, but the invention is not limited to this. The combustion pressure control device can also be configured so that it does not include the coil spring 54 and so that the first stem 55b and the second stem 55c are fastened to each other. That is, the stem may also be an integral piece. In this combustion pressure control device, a clearance is formed between the upper core 121 and the mover 129. The clearance is formed larger than the amount of movement of the mover 129 when the fluid spring 63 contracts. That is, the clearance is formed so that the tapered plug part 55a can freely move. When the pressure of the combustion chamber reaches the control pressure, the first stem 55b and the second stem 55c move integrally in a direction away from the combustion chamber. At this time, due to the fluid spring 63 contracting, the pressure of the combustion chamber can be controlled.

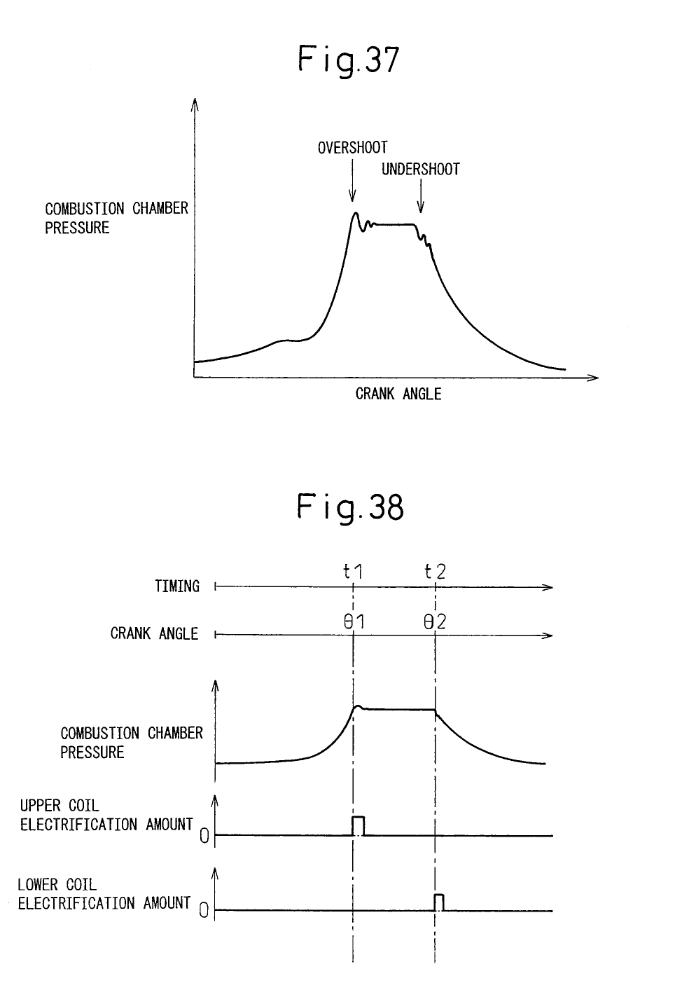

FIG. 37 shows a graph of the pressure of the combustion chamber of an internal combustion engine which is provided with the tube-shaped member and the fluid spring etc. FIG. 37 is a graph of the pressure of the combustion chamber of an internal combustion engine which is provided with the first combustion pressure control device in, for example, Embodiment 1. When the pressure of the combustion chamber reaches the control pressure, due to the delayed response of the combustion pressure control device, sometimes overshoot occurs in the pressure of the combustion chamber. When the fuel burns, the operation of the fluid spring 63 contracting and the movement of the tube-shaped member 61 sometimes are delayed from the rise of the pressure of the combustion chamber 5. For this reason, sometimes the pressure of the combustion chamber 5 temporarily exceeds the control pressure.

Further, when the pressure of the combustion chamber falls from the control pressure, due to the delayed response of the combustion pressure control device, sometimes undershoot occurs in the pressure of the combustion chamber. When the pressure of the combustion chamber falls from the control pressure, the operation of the fluid spring 63 extending and the movement of the tube-shaped member 61 are sometimes delayed from the drop of the pressure of the combustion chamber. For this reason, sometimes the pressure of the combustion chamber 5 temporarily excessively falls.

FIG. 38 is a time chart of the first operational control in the combustion pressure control device of the present embodiment. At the time of normal operation, in the time period when the pressure of the combustion chamber reaches the control pressure, the upper coil 123 and the lower coil 124 are not electrified. At the timing t1, the pressure of the combustion chamber reaches the control pressure. At the combustion pressure control device of the present embodiment, the upper coil 123 is electrified for a short time from the timing t1. Alternatively, it is electrified in a pulse manner. By electrification of the upper coil 123, the upper core 121 is magnetized. The mover 129 is pulled in a direction away from the combustion chamber. As a result, the force can be applied to the exhaust valve 8 in a direction where the volume of the combustion chamber 5 becomes larger and the pressure becomes smaller. For this reason, overshoot when the pressure of the combustion chamber 5 reaches the control pressure can be suppressed.

Further, the pressure of the combustion chamber starts to fall at the timing t2. In the first operational control of the present embodiment, the lower coil 124 is electrified for a short time from the timing t2. Alternatively, it is electrified in a pulse state. By electrifying the lower coil 124, the lower core 122 is magnetized. The mover 129 is pulled in a direction toward the combustion chamber. The force can be applied to the exhaust valve 8 in a direction where the volume of the combustion chamber 5 becomes smaller and the pressure of the combustion chamber 5 becomes larger. For this reason, undershoot can be suppressed when the pressure of the combustion chamber 5 starts to fall from the control pressure. In this regard, when electrifying the lower coil 124 so as to suppress undershoot, if the amount of electrification of the lower coil 124 becomes too large, the exhaust valve 8 is liable to open. For this reason, the lower coil 124 is preferably electrified by less than the amount of electrification by which the on-off valve opens.

In the present embodiment, the upper coil is electrified when the pressure of the combustion chamber reaches the control pressure. Further, the lower coil is electrified when the pressure of the combustion chamber starts to decrease. The timing of electrification is not limited to this. The upper coil can be electrified near the timing at which the pressure of the combustion chamber reaches the control pressure. Alternatively, the lower coil can be electrified near the timing at which the pressure of the combustion chamber starts to decrease.

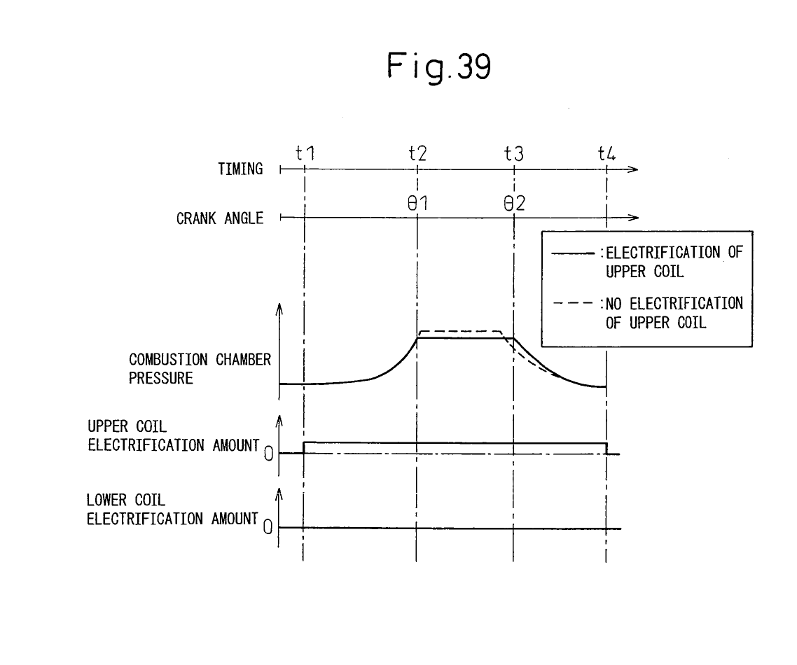

FIG. 39 shows a time chart of the second operational control of the combustion pressure control device in the present embodiment. In the second operational control, in the time period during which the pressure of the combustion chamber reaches the control pressure, the coil which biases the on-off valve in the direction toward the outside of the combustion chamber is electrified. In the second operational control, the upper coil 123 is electrified from the timing t1 at which the pressure of the combustion chamber starts to rise in the compression stroke to the timing t4 at which the pressure of the combustion chamber finishes falling in the expansion stroke.

By electrifying the upper coil 123, the upper core 121 is magnetized. The mover 129 is pulled to the upper core 121. The mover 129 is biased in a direction away from the combustion chamber. The exhaust valve 8 is given a biasing force in a direction where the volume of the combustion chamber 5 becomes larger. For this reason, the pressure of the combustion chamber when the fluid spring 63 starts to contract, that is, the control pressure, can be lowered. For example, an operating state detecting device can be used to detect the operating state and the control pressure can be changed in accordance with the respective operating states.

Further, by adjusting the amount of electrification which is applied to the upper coil, the control pressure can be freely adjusted. For example, by increasing the amount of electrification which is applied to the upper coil, the control pressure of the combustion chamber can be lowered.

In the second operational control in the present embodiment, the upper coil is electrified from the timing at which the rise of the pressure of the combustion chamber starts to the timing at which the fall of the pressure of the combustion chamber ends. The timing of electrification is not limited to this. The upper coil can be electrified in a time period of at least part of the time period at which the pressure of the combustion chamber reaches the control pressure. For example, the upper coil can be electrified in the time period from right before the pressure of the combustion chamber reaches the control pressure to right after the pressure of the combustion chamber starts to fall from the control pressure.

In this regard, if electrifying in a time period other than the time period at which the pressure of the combustion chamber reaches the control pressure, if the amount of electrification of the upper coil is too large, the magnetic force of the upper coil is liable to cause the tube-shaped member to move. For this reason, the amount of electrification of the upper coil is preferably less than the amount of electrification where the tube-shaped member moves.

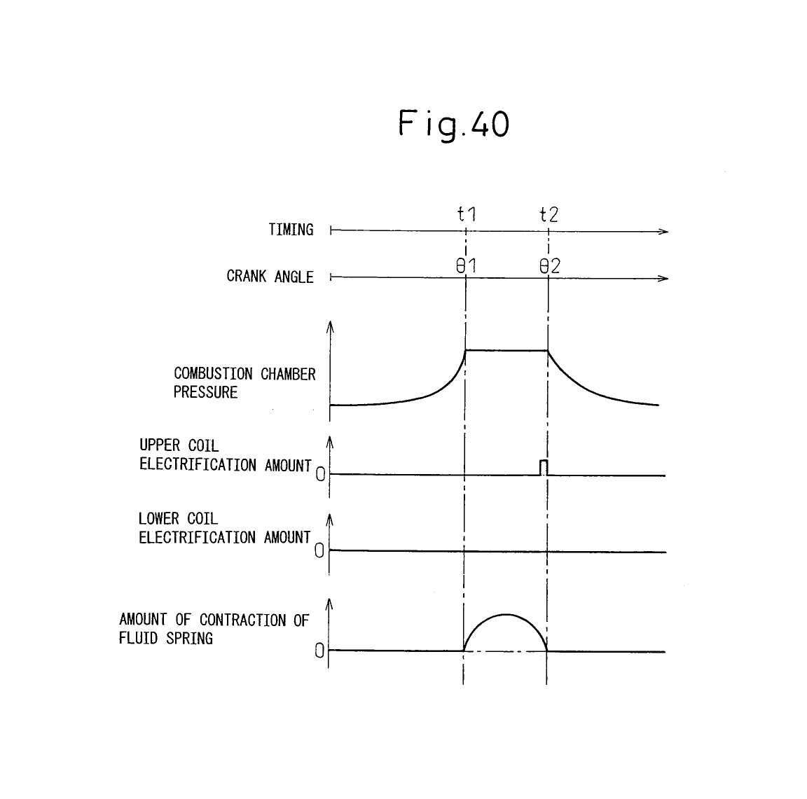

FIG. 40 shows a time chart of the third operational control in the combustion pressure control device in the present embodiment. In the third operational control, control is performed to electrify the upper coil right before the fluid spring extends and returns to its original state.

In the third operational control of the present embodiment, at the timing t1, the tube-shaped member 61 moves in a direction away from the combustion chamber 5 and the fluid spring 63 contracts. After this, the tube-shaped member 61 moves to the side heading toward the combustion chamber 5 and the fluid spring 63 extends. At the timing t2, the tube-shaped member 61 returns to its original position. At the timing t2, when the end part of the tube-shaped member 61 reaches the bottom of the engaging part 60b of the frame member 60, sometimes noise and vibration are caused.

In the third operational control of the present embodiment, right before the end part of the tube-shaped member 61 reaches the engaging part 60b of the frame member 60, the coil for biasing the exhaust valve 8 in the closing direction is electrified. In the present embodiment, the upper coil 123 is electrified in a short period right before the timing t2. Alternatively, it is electrified in a pulse manner. By performing this control, the speed when the tube-shaped member 61 reaches the bottom of the engaging part 60b of the frame member 60 can be slowed and the noise and vibration which occur when the tube-shaped member 61 reaches the bottom can be suppressed. Further, the pressure of the combustion chamber can be kept from becoming unstable due to the vibration, etc.

In the third operational control of the present embodiment, the upper coil is electrified right before the tube-shaped member reaches the bottom of the engaging part of the frame member, but the invention is not limited to this. The upper coil may also be electrified during the time period when the tube-shaped member is moving toward the combustion chamber. In this control as well, the speed of the tube-shaped member when the tube-shaped member reaches the bottom can be reduced and noise and vibration can be suppressed.

As shown in the first operational control to the third operational control, the combustion pressure control device in the present embodiment can drive the electromagnetic drive device in the time period when the pressure of the combustion chamber reaches the control pressure so as to adjust the pressure of the combustion chamber.

The rest of the configuration, actions, and effects are similar to those of Examples 1 to 3, so the explanations will not be repeated.

The above embodiments can be suitably combined. In the above figures, the same or corresponding parts are assigned the same reference signs. Note that, the above embodiments are illustrations and do not limit the invention. Further, in the embodiments, are changes which are included in the claims are intended.

### REFERENCE SIGNS LIST

1 engine body
4 cylinder head
5 combustion chamber
6 intake valve
7 intake port
8 exhaust valve
9 exhaust port
31 electronic control unit
45 fuel property sensor
51 valve spring
54 coil spring
55a tapered plug part
55b first stem
55c second stem
60 frame member
61 tube-shaped member
63 fluid spring
64 pipe-shaped member
64b blocking member
70 variable valve timing device 90, 91 exhaust cam 90c, 91c recessed part
95, 96 abutting part
95a, 96a projecting part
97 switching device
120 electromagnetic drive device
123 upper coil
124 lower coil
129 mover

1. An internal combustion engine provided with
an on-off valve which has a shaft-shaped part and tapered plug part and is formed to be able to open and close a passage which is communicated with a combustion chamber,
a support structure which includes a passage which communicates with the combustion chamber and which supports the on-off valve,
an interposed member which is arranged in a region where the on-off valve is arranged in the passage which communicates with the combustion chamber and which is engaged with the tapered plug part of the on-off valve at one end part which faces the combustion chamber,
a spring device for biasing the interposed member to the side which faces the combustion chamber,
an operating state detecting device which detects an operating state of the internal combustion engine, and
a movement restricting device which restricts an amount of movement of the interposed member, wherein
the interposed member is formed to be able to move substantially parallel to a direction of movement of the on-off valve and abuts against the spring device at the other end part at the opposite side from the one end part,
the spring device is formed so as to contract using a change in pressure of the combustion chamber as a drive source when the pressure of the combustion chamber reaches a predetermined control pressure,
when the combustion chamber reaches the control pressure during the time period from the compression stroke to the expansion stroke of a combustion cycle, the spring device contracting causes the tapered plug part and the interposed member to move toward the outside of the combustion chamber and the combustion chamber to increase in volume, and
the engine detects the operating state of the internal combustion engine, selects a maximum pressure of the combustion chamber in accordance with the detected operating state, and uses the selected maximum pressure of the combustion chamber as the basis to restrict the amount of movement of the interposed member.

2. (canceled)

3. The internal combustion engine as set forth in claim 1, further provided with
a blocking device which blocks at least part of the passage which communicates with the combustion chamber, wherein
the blocking device is formed so as to promote a circumferential direction flow or an axial direction flow in the combustion chamber the smaller a flow sectional area of the passage which communicates with the combustion chamber, and
the smaller the flow sectional area of the passage which communicates with the combustion chamber, the smaller the movement restricting device restricts the amount of movement of the interposed member and the larger the maximum pressure of the combustion chamber is made.

4. The internal combustion engine as set forth in claim 1, wherein
a plurality of on-off valves are arranged for a single combustion chamber,
the engine is further provided with a plurality of interposed members and a plurality of spring devices which are arranged corresponding to the plurality of on-off valves, and
the plurality of spring devices are formed so that elastic forces become smaller the larger the total weights of the moving members which include the tapered plug parts and the interposed members.

5. The internal combustion engine as set forth in claim 1, wherein
the shaft-shaped part of the on-off valve includes a first valve shaft part which is connected to the tapered plug part and a second valve shaft part which is connected to the first valve shaft part through an elastic member, and
the elastic member has an elastic force by which it contracts corresponding to the amount of contraction of the spring device when the pressure of the combustion chamber reaches the control pressure and the spring device contracts and has an elastic force by which it does not contract when opening the on-off valve for opening the passage which communicates with the combustion chamber.

6. The internal combustion engine as set forth in claim 1, further provided with
a valve biasing member which biases the on-off valve in a direction by which the on-off valve closes, wherein
the spring device is arranged at the inside of the valve biasing member or at the outside so as to surround the valve biasing member.

7. The internal combustion engine as set forth in claim 1, further provided with
a cam for driving the on-off valve and
a variable valve mechanism which changes a phase of the cam relative to a crank angle, wherein
the cam has a recessed part which is formed so that the on-off valve can move during the time period while the spring device is contracted, and
the variable valve mechanism is used to change the phase of the recessed part of the cam so as to restrict the amount of movement of the on-off valve during the time period while the spring device is contracted.

8. The internal combustion engine as set forth in claim 1, further provided with
an electromagnetic drive device for driving the on-off valve, wherein
the electromagnetic drive device is driven during the time period while the pressure of the combustion chamber reaches the control pressure so as to adjust the pressure of the combustion chamber.
